(19) United States
(12) Patent Application Publication
(10) Pub. No.: US 2007/0250390 A1
(43) Pub. Date: Oct. 25, 2007

(54) Internet advertising method and system

(75) Inventors: Antony H. Lee, Greenwich, CT (US); Camilo E. Cucalon, Somers, NY (US)

Correspondence Address: COLEMAN SUDOL SAPONE, P.C., 714 COLORADO AVENUE, BRIDGE PORT, CT, 06605-1601, US

(73) Assignee: ADVANCED COMMERCE STRATEGIES, INC., Greenwich, CT (US)

(21) Appl. No.: 11/788,895

(22) Filed: Apr. 23, 2007

Related U.S. Application Data
(60) Provisional application No. 60/794,430, filed on Apr. 24, 2006.
(60) Provisional application No. 60/801,162, filed on May 17, 2006.
(60) Provisional application No. 60/851,433, filed on Oct. 13, 2006.

(51) Int. Cl. G06Q 30/00

(52) U.S. Cl. 705/14

(57) ABSTRACT

In an Internet or online advertising method, a server computer maintains a an electronic site or page accessible via a computer network and transmits to a user computer accessing the site or page advertisements selected in accordance with buying habits of individual users and independently of content on the site or page. The transmitting of the site or page and the transmitting of the advertisements is such that the advertisements and the sites or pages are simultaneously displayed on user computer monitors. The sites or pages may include Internet search results, the advertisements being independent of or unrelated to the content of displayed search results.

### CROSS-REFERENCE TO RELATED APPLICATION

This application claims the benefit of U.S. Provisional Patent Application No. 60/794,430 filed Apr. 24, 2006, U.S. Provisional Patent Application No. 60/801,162 filed May 17, 2006, and U.S. Provisional Patent Application No. 60/851,433 filed Oct. 13, 2006.

### BACKGROUND OF THE INVENTION

The invention relates to advertising done over the global computer network known as the Internet. More particularly, this invention relates to a method and an associated system for providing targeted advertising to users accessing the Internet.

Advertising over the global computer network known as the Internet typically involves the presentation of so-called banner ads in conjunction with, i.e., simultaneously with search results. Invariably, the content of the advertising is connected in some logical way with the subject matter of the search. Thus, if a person seeks information on malaria or sleeping sickness in Africa, the banner ads might be directed to safari excursions in Africa or compositions for treating or preventing malaria or sleeping sickness (e.g., mosquito repellants). If an individual user searches for a certain kind of consumer product, then the banner advertising is exemplarily directed towards competing consumer products of products that may be used in association with the searched product. For instance, if a computer user institutes a search for kitchen knives, the banner advertising might promote automatic blenders and dicers or pots and pans. If a user seeks information on a motion picture video, advertisements may be directed to electronic playback products or to other motion picture videos with purportedly related content.

This behavioral advertising is limited in effectiveness, since many searches do not stem from, and are not connected to, consumer purchase interests. The purpose of any particular search may be so remote from a commercial purpose that the advertising “falls on deaf ears.”

### OBJECTS OF THE INVENTION

An object of the present invention is to provide a method and/or an associated system for advertising over a computer network such as the Internet.

A further object of the present invention is to provide a method of generating a database for use in providing advertisements and consumer purchase information to individual users over a computer network such as the Internet.

These and other objects of the invention will be apparent from the descriptions and drawings herein. Although every object of the invention is believed to be attained in at least one embodiment of the invention, there is not necessarily any single embodiment that achieves all of the objects of the invention.

### SUMMARY OF THE INVENTION

The present invention provides a method for providing online shoppers with information particularly suited to their interests. In contrast to conventional online advertising, which presents ads related to the subject matter of Web page or search results viewed by the online user, the present invention provides advertising selected in accordance with the past buying behavior of the online user and independently of other content on the user's computer monitor. The present invention contemplates a database containing data as to purchases made by the particular user, as well as by other users, at multiple Web sites across the Internet. This data is garnished on the user computers, rather than from sellers or merchants or credit/debit card companies. Advertisements are selected in accordance with online users' purchase habits over time rather than by what the user is viewing on their computer monitor at any instant.

Applicants' method, because it obtains information pertaining to purchases made by many online shoppers at many different Web sites including merchant Web sites, enables the collection and statistical analysis of data from multiple merchants and with respect to multiple products. Online shoppers can be provided with collated information as to merchants and products. For instance, merchants may be ranked (e.g., in message toast windows or screen inserts) by popularity (sales volume) and/or reliability (returns rate). This ranking may be performed on a product by product basis. Thus, where an online shopper is looking at a particular brand of athletic shoe at a particular merchant's Web site, message toast windows may be presented on the monitor or display screen of the online shopper to inform the shopper as to the popularities of alternative merchants or retailers of that brand, or the popularities of alternative brands of the same kind of product. Alternatively, a message toast might list related products in which a particular online shopper may have an interest based on statistical analysis of the purchasing behavior of other online shoppers having similar buying habits to the particular online shopper.

The present method contemplates that the online identity of the particular online shopper may be determined so that advertisements and other consumer information presented to the particular online user may be modeled in accordance with the actual online purchasing behavior of that user. During the purchase of goods or services online, the actual identity of the user (name and shipping/billing address) may be gleaned from the purchase particulars extracted from the user's computer during the purchase process. This identity may be stored on the user computer for later use in identifying the user computer when that computer is accessing the Internet or World Wide Web for other purposes. In the latter event, the identity that is actually determined is the identity of the computer that is used to make online purchases, since the individual who is online may be different from the purchasing individual identified in the course of prior purchasing events.

Accordingly, identification data is placed on the user's computer, for instance, by a Web browser plug-in that enables a server computer to associate the user's computer with the user's past purchase data stored in a database of consumer purchase data. As discussed elsewhere herein, the same Web browser plug-in software sifts and captures or extracts consumer purchase data by analyzing the purchases being made on a user's machine via an Internet browser.

Consumer purchase data is sent to the database via the Internet when the user is on the Web. The browser plug-in uploads the relevant extracted information to the database. The consumer purchase data stored in the database may be used to organize consumer or product search results in any order determinable from or consistent with the consumer purchase data stored in the database of consumer purchasing histories. For instance, one might order a search for a particular product according to the numbers of styles or colors or product configurations available from different online merchants. Or merchants could be arranged in accordance with the average sales price including discounts and rebates. Alternatively, search results could be ordered in accordance with merchant popularity (sales volume), whether as to a particular brand of a specific kind of product or to the type of product. This ranking of merchants would be integrated into the search results. Alternatively, merchant ranking may be presented to the online computer user in a separate window aside from the results of a requested search.

The browser plug-in determines what a user has purchased online. The browser plug-in may also determine the name and address of the particular buyer. In that event, the information stored in the database of consumer purchasing behavior may include data garnished from different computers used by the same individuals, for instance, work computers and home computers. Advertisements provided to a user computer may be based in part on purchases made via a different online computer by the same user. Should two or more users be associated with a given online computer, different advertisements may be provided to that computer, for simultaneous or successive display, that are directed to the different users as modeled on the purchasing behavior of the respective users.

After a user has made a purchase online, that user will receive emails from the merchant that the order is shipped, cancelled, delayed, etc. The plug-in software detects these merchant emails and deciphers them as well. The browser plug-in extracts this information and relays it to the database. Thus, the database stores data about how long it takes to ship ordered goods, how many items are returned, etc.

The consumer purchase data stored in the database may be used to organize consumer or product search results based on product popularity. Thus, where a search is requested as to golf clubs, search results may be listed in order of decreasing sales volume by brand. Or where a search is requested of a particular brand of automotive sedan, the search results may be ranked in order of decreasing popularity by color. Again, rankings based on consumer purchase behavior as determined from purchases made via multiple online computers may be integrated with requested search results or may be provided separately in a message toast on a computer screen.

Again, should an individual user download the COSMOS plug-in onto two separate machines (e.g., at home and at work) and even use two separate email addresses in the buying process, it will be possible to link the activity on the separate machines and present the user with a unified dashboard (purchase history summary) and related information set on whatever machine the individual shopper is using.

A consumer purchase monitoring and data extraction system in accordance with the present invention may include social networking capabilities allowing consumers to share details of the actual purchasing experiences with friends and family.

Particular online shoppers whose purchasing behavior has been monitored and extracted for storage in the database of consumer purchasing behavior may be presented with rewards and free gifts that are not randomly selected, but that are selected in accordance with the individual shoppers' buying habits or interests, as well as the interests of similar online shoppers. Thus, where a particular online shopper has bought skiing equipment online, it might be found that other online shoppers who bought skiing equipment also purchased competitive bicycling gear. In that case, the particular online shopper who has bought skiing equipment may be presented with rewards and free gifts of bicycling shorts, gloves and jerseys.

Other kinds of consumer statistics such as product return rates of different merchants may be presented to online shoppers, especially to shoppers who have participated in the creation of the consumer behavior database. Thus, when an online shopper is on a Web site of a given merchant, the shopper may be presented with a pop-up window or message toast providing the returns rate not only of that merchant but also of competing online merchants. Typically, the returns rate is provided on a product-by-product basis. Accordingly, when an online shopper is looking at casual wear shirts, a pop-up window or message toast presents returns rates for such shifts, merchant by merchant for multiple brands or for one brand.

A business method in accordance with the present invention comprises (a) automatically determining an identity of an online shopping entity associated with a user computer logged on a computer network, and (b) automatically selecting at least one advertisement in accordance with online purchasing behavior embodied in multiple purchases made over the computer network at a plurality of different Web sites by the online shopping entity. The method additionally comprises (c) transmitting the at least one advertisement to the user computer via the computer network so that the advertisement may be presented in at least one display screen of the user computer simultaneously with primary information transmitted to the user computer via the computer network, the primary information being organized for presentation in the at least one display screen of the user computer. The selecting of the at least one advertisement is made independently of and separately from the primary information.

Pursuant to another feature of the present invention, the selecting of the at least one advertisement includes accessing a database of consumer purchase data including multiple online purchase histories each associated with a respective online computer. The selecting of the at least one advertisement may further include comparing the online purchasing behavior of the online shopping entity with statistically collated online purchase history information in the database to determine at least one potential product interest. The consumer purchase data is collected by monitoring online purchases made via the online computers on the computer network. The monitoring of online purchases may include collecting of particulars as to transactions using screen scraper or data extraction software resident at least in part on the online computers and the user computer.

Pursuant to another feature of the present invention, the primary information displayed on the user computer is (a) results of a search executed over the computer network in response to a query from the user computer or (b) a Web page accessed by the user computer via the computer network. The search is typically a product search for information pertaining to one or more potential product purchases, while the Web page is typically on a merchant Web site. The method may then further comprise transmitting to the user computer additional information derived from correlated consumer purchase history data. The additional information is adapted for display simultaneously with the primary information in the display screen. The transmitting of the additional information may be accomplished in part by accessing the database of consumer purchase data including multiple online purchase histories each associated with a respective online shopping entity. The additional information may be obtained from a statistical analysis of the consumer purchase data.

It is to be noted that the terms “purchase data,” “purchasing behavior,” “purchase history information,” etc., are used herein to denote all aspects of online interactions between consumers or shoppers and merchants. These terms therefore include or cover such information as products purchased, the times at which purchases are made, shipping times, product returns, delays in receiving credit for product returns, damage to shipped goods, etc.

An online computer method comprises, in accordance with the present invention, (i) storing, in a memory of a user computer, an identity of an online shopping entity, (ii) accessing a computer network via the user computer, (iii) thereafter transmitting the stored identity over the computer network to a source computer, (iv) receiving, from the source computer via the computer network, at least one advertisement selected in accordance with online purchasing behavior embodied in multiple purchases made over the computer network at a plurality of different Web sites by the online shopping entity, (v) receiving primary information via the computer network, the primary information being organized for presentation in at least one display screen on the user computer, (vi) displaying the advertisement on a monitor of the user computer simultaneously with the primary information. The advertisement is selected independently of and separately from the primary information.

The online shopping entity may be a person whose identity has been ascertained, during online purchasing activity, by data extraction software resident on the user computers, for instance, in a browser plug-in. Alternatively, the online shopping entity may be the user computer itself.

As indicated above, the advertisement is preferably selected in accordance with consumer purchase data stored in a common database, the consumer purchase data including multiple online purchase histories each associated with a respective online computer. The selection of the advertisement may result from comparing the online purchasing behavior of the online shopping entity with statistically collated online purchase history information in the database to determine at least one potential product interest of the online shopping entity.

Where the primary information is (a) results of a search executed over the computer network in response to a query from the user computer or (b) a Web page accessed by the user computer via the computer network, the accessing of the computer network may include a step of (i) transmitting a search query to a search engine or (ii) accessing the Web page, respectively.

If the search is a product search for information pertaining to one or more potential product purchases, or if the Web page is on a merchant Web site, the method may also comprise receiving additional information such as merchant popularity information and product popularity information and displaying the additional information on the computer monitor simultaneously with the primary information. The additional information may be obtained from a statistical analysis of the consumer purchase data. Merchant popularity information typically includes sales volumes of different sellers, while product popularity information typically includes sales volumes of different products according to a product parameter taken from the group consisting of brands, styles, colors, and functions. It is to be understood, however, that the additional information, provided for the benefit of the individual user, may be any kind of information that may be statistically compiled from purchase history information collected from multiple online users.

A data collection method in accordance with the present invention comprises (1) monitoring online activity of a user conducted on a computer network via a respective user computer, (2) during the monitoring of the online activity, automatically determining whether the user is engaged in online purchase activity, (3) upon detecting that an individual user has entered into an online transaction, extracting particulars of the transaction from the user computer, (4) transmitting the particulars of the transaction to a database of consumer purchasing behavior, and (5) automatically establishing an identity of the user computer for reference in future online activity performed via the user computer.

The method may further comprise loading screen scraper or data mining software on the user computer and running the software during operation of a browser on the user computer. Establishing the identity of the user computer may be accomplished by storing identity information in the memory of the user computer. The identity information may be an arbitrary alphanumeric identification unique to the individual user computer. Alternatively or additionally, the identity information may include particulars associated with a user of the computer. For instance, where a user makes an online purchase via a computer, the user's name and shipping/billing address may be extracted and placed in the computer memory for future reference when the user computer is online for shopping or other purposes.

A business computer system in accordance with the present invention comprises at least one server computer connected to a computer network and a database of consumer purchase data including identities of multiple online shopping entities and further including multiple online purchase histories each associated with a respective one of the online shopping entities. The multiple online purchase histories each include multiple purchases made over the computer network at a plurality of different Web sites by the online shopping entities. The server computer is operatively connected to the database. The server computer is operatively connected to a memory that stores advertisements, the server computer selecting advertisements for display on a computer associated with a given online shopping entity simultaneously with but independently of other information and in accordance with online purchasing behavior embodied in multiple purchases made over the computer network at a plurality of different Web sites by the given online shopping entity.

According to a further aspect of the present invention, the server computer includes means for comparing the online purchasing behavior of the given online shopping entity with statistically collated online purchase history information in the database to determine at least one potential product interest of the given online shopping entity. The server computer may additionally include means for monitoring online purchases made via user computers on the computer network and for updating the database to incorporate purchase data from the user computers.

According to another aspect of the present invention, the server computer further includes (A) means for extracting or deriving, from data in the database, additional information derived via statistical tools from purchasing behavior data in the database and (B) means for transmitting the additional information to the given one of the user computers in a form adapted for display simultaneously with the other information one the monitor.

A computer network method comprises, in accordance with the present invention, maintaining a database of consumer purchase data including identities of multiple online shopping entities and further including multiple online purchase histories each associated with a respective one of the online shopping entities. The multiple online purchase histories each include multiple purchases made over the computer network at a plurality of different Web sites by the respective online shopping entities. The method also comprises accessing the database to provide consumer assistance information to a given online shopping entity while the same is logged onto the computer network and transmitting the consumer assistance information to the given online shopping entity for display on a computer monitor simultaneously with other information transmitted to the given online shopping entity.

By way of example, the consumer assistance information may be advertisements unrelated to the other information, merchant popularity information, merchant reliability data, product popularity information, products related to a product searched by the given one of the user computers, or rewards and free gifts offered to the given online shopping entity.

The method may further comprise automatically determining an identity of the given online shopping entity, the consumer assistance information being selected in accordance with the determined identity of the given online shopping entity. The method may also comprise processing information from the consumer purchase history of the given online shopping entity to determine potential future purchases by the online shopping entity, processing information from the consumer purchase histories of other online shopping entities to determine purchasing interests thereof, and comparing the determined purchasing interests of the given online shopping entity with the determined purchasing interests of the other online shopping entities to determine at least one potential product interest of the given online shopping entity.

A business computer system in accordance with the present invention comprises at least one server computer connected to a computer network for providing information to user computers via the computer network and a database operatively connected to the server computer and storing data pertaining to buying habits of individual users determined in accordance with purchases made over the computer network via respective user computers connected to the computer network. The server computer is programmed to transmit the information via the computer network to the user computers in response to queries from the user computers, determine identities of the user computers, and transmit to each of the user computers a respective advertisement selected in accordance with past online purchases made at multiple different Web sites via the respective one of the user computers. The advertisements are transmitted to the user computers for simultaneous display with the information on user computer monitors. The advertisements havie content independent of and separate from the information.

A business method in accordance with the present invention comprises maintaining a portal on a computer network, conducting searches for information via the computer network in response to queries from user computers connected to the computer network, the conducting of searches including accessing a database of consumer purchasing behavior, and transmitting, to the user computers, results of respective searches conducted via the computer network, the transmitted results of the searches including statistics of consumer purchasing behavior pertaining to a class taken from the group consisting of products and merchants or sellers. The transmitted results of the searches include a list of merchants ordered in accordance with merchant sales made in response to orders made online via individual user computers.

A business method in accordance with the present invention comprises (a) maintaining a portal on a computer network (such as the Internet), (b) conducting searches for information via the computer network in response to queries from user computers connected to the computer network, (c) transmitting, to the user computers, results of respective searches conducted via the computer network, and (d) transmitting, to the user computers, advertisements selected in accordance with buying habits of individual users determined in accordance with purchases made over the computer network via the respective user computers. The transmitting of the search results and the transmitting of the advertisements is such that the advertisements and the search results are simultaneously displayed on user computer monitors.

A business method in accordance with another embodiment of the present invention comprises (i) maintaining a portal on a computer network, (ii) conducting searches for information via the computer network in response to queries from user computers connected to the computer network, (iii) transmitting, to the user computers, results of respective searches conducted via the computer network, and (iv) transmitting, to the user computers, advertisements selected in accordance with buying habits of individual users, independently of the queries and independently of the results of the searches. The transmitting of the search results and the transmitting of the advertisements is such that the advertisements and the search results are simultaneously displayed on user computer monitors.

Pursuant to further features of the present invention, the method also comprises, for each given one of the queries, determining an identity of the respective user computer originating the given one of the queries, and the transmitting of the advertisements to the user computers includes, for each given one of the queries, accessing a database of consumer purchase data and selecting at least one respective advertisement in accordance with the determined identity of the respective user computer. The consumer purchase data may be collected by monitoring purchase activity of users conducted on the computer network via respective user computers. More particularly, the monitoring of purchase activity may include collecting of particulars as to transactions using screen scraper software. Determining the identity of a respective user computer may include receiving identification information from the respective user computer. The identification information may include a code assigned to the individual user computer by or through resident browser plug-in software for monitoring consumer purchases. The identification information may alternatively or additionally include a code associated with each identifiable individual using the computer for online shopping. The codes may be associated with actual name and address data extracted by the resident browser plug-in software for monitoring consumer purchases.

Pursuant to another feature of the present invention, the searches conducted may include product searches, that is, searches for information pertaining to potential product purchases. In that case, the searching includes accessing a database of consumer purchase data. The database includes such information as the sales volume of different sellers, and that information is passed on to the persons requesting the product searches. Sales volume is an indicator of the goodwill and reputation of the various online purveyors of merchandise. Thus, the people potentially interested in making product purchases via the Internet are informed as to the reliability, trustworthiness and professionalism of different sellers. This information may be communicated in different ways to the search requesters, for instance, by a rating or ranking protocol.

A business method pursuant to another embodiment of the present invention comprises maintaining an electronic site or page accessible via a computer network and transmitting, to user computers accessing the site or page, advertisements selected in accordance with buying habits of individual users determined in accordance with purchases made over the computer network via the respective user computers. The transmitting of the site or page and the transmitting of the advertisements is such that the advertisements and the sites or pages are simultaneously displayed on user computer monitors.

A business method in accordance with a related embodiment of the present invention comprises maintaining an electronic site or page accessible via a computer network and transmitting to user computer accessing the site or page advertisements selected in accordance with buying habits of individual users and independently of content on the site or page. The transmitting of the site or page and the transmitting of the advertisements is such that the advertisements and the sites or pages are simultaneously displayed on user computer monitors.

Pursuant to additional features of the present invention, the method further comprises, for each user computer accessing the site or page, determining an identity of the respective user computer, while transmitting advertisements to the user computers includes accessing a database of consumer purchase data and selecting at least one respective advertisement in accordance with the determined identity of the respective user computer. The consumer purchase data may be collected by monitoring purchase activity of users conducted on the computer network via respective user computers. The monitoring of purchase activity may include collecting of particulars as to transactions using screen scraper software. Determining the identity of a respective user computer may include receiving identification information from the respective user computer. As indicated above, the identification information may include a code assigned to the individual user computer by or through resident browser plug-in software for monitoring consumer purchases. The identification information may, alternatively or additionally, include a code associated with each identifiable individual using the computer for online shopping. The codes may be associated with actual name and address data extracted by the resident browser plug-in software for monitoring consumer purchases.

Thus, the present invention contemplates that advertisement content may be typically unrelated to the immediate behavior of the individual user. Instead of gearing advertisement content to users' search requests or Web page content, the advertisements are selected independently of users' search requests and Web page content. In the vast majority of cases there will be no actual and no apparent relationship between the content or subject matter of the advertising and the subject matter displayed elsewhere on a user's monitoring during Internet search or Web surfing.

A business computer system comprises, in accordance with the present invention, at least one server computer connected to a computer network for maintaining a portal thereon, and a database operatively connected to the server computer, the database storing data pertaining to buying habits of individual users determined in accordance with purchases made over the computer network via respective user computers connected to the computer network. The server computer is programmed to (1) conduct searches for information via the computer network in response to queries from the user computers, (2) transmit, to the user computers, results of respective searches conducted via the computer network, and (3) transmit, to the user computers, advertisements selected in accordance with buying habits of individual users, the advertisements being transmitted to the user computers together with the search results for simultaneous display with the search results on user computer monitors.

A business computer system comprises, in another embodiment of the present invention, at least one server computer connected to a computer network for maintaining a portal on the computer network, and a database operatively connected to the server computer, the database storing data pertaining to buying habits of individual users. The server computer is programmed to (A) conduct searches for information via the computer network in response to queries from the user computers, (B) transmit, to the user computers, results of respective searches conducted via the computer network, and (C) transmit, to the user computers, advertisements selected in accordance with buying habits of individual users, independently of the queries and independently of the results of the searches. The advertisements are transmitted to the user computers together with the search results for simultaneous display with the search results on user computer monitors.

According to another feature of the present invention, the system further comprises means for determining, for each given one of the queries, an identity of the respective user computer originating the given one of the queries and for selecting at least one respective advertisement in accordance with the determined identity of the respective user computer. Determining the identity of a respective user computer may include means for receiving identification information from the respective user computer. The identification information may include a code assigned to the individual user computer by or through resident browser plug-in software for monitoring consumer purchases. The identification information may alternatively or additionally include a code associated with each identifiable individual using the computer for online shopping. The codes may be associated with actual name and address data extracted by the resident browser plug-in software for monitoring consumer purchases.

According to a further feature of the present invention, the system also comprises means for monitoring purchase activity of users conducted on the computer network via respective user computers. The monitoring means may include a computer programmed to interface or communicate with screen scraper software on the user computers.

The server computer may be programmed to conduct online product searches for information pertaining to potential product purchases and for accessing a database of consumer purchase data. In that case, the server computer is additonally programmed to transmit results including, for at least some individual types of products searched, information pertaining to sellers of the individual types of products. The information pertaining to sellers of the individual types of products typically includes sales volume of different sellers.

A further embodiment of a business computer system in accordance with the present invention comprises at least one computer connected to a computer network for maintaining an electronic site or page accessible via the computer network and a database operatively connected to the one computer, the database storing data pertaining to buying habits of individual users. The one computer is programmed to transmit, to user computers accessing the site or page, advertisements selected in accordance with buying habits of individual users determined in accordance with purchases made over the computer network via the respective user computers. The advertisements are transmitted to the user computers together with the site or page for simultaneous display with the site or page on user computer monitors.

Yet another embodiment of a business system in accordance with the present invention comprises at least one computer connected to a computer network for maintaining an electronic site or page accessible via the computer network and a database operatively connected to the one computer, the database storing data pertaining to buying habits of individual users. The one computer is programmed to transmit, to user computers accessing the site or page, advertisements selected in accordance with buying habits of individual users and independently of content on the site or page for display on the site or page on user computer monitors. The advertisements are transmitted to the user computers together with the site or page for simultaneous display with the site or page on user computer monitors.

According to supplemental features of the present invention, the system further comprises means for determining, for each user computer accessing the site or page, an identity of the respective user computer and for selecting at least one respective advertisement in accordance with the determined identity of the respective user computer. The means for determining the identity of a respective user computer may include means for locating a user or computer identification code on the respective user computer. The system may further comprise means for monitoring purchase activity of users conducted on the computer network via respective user computers. The means for monitoring may include a computer programmed to interface or communicate with screen scraper software on the user computers.

A data collection method comprises, in accordance with the present invention, (i) monitoring email of a user conducted on a computer network via a respective user computer, (ii) during the monitoring of the email, automatically determining whether the email evidences online purchase activity by the user, (iii) upon detecting from the user's email that the user has entered into an online transaction, extracting particulars of the transaction from email of the user, (iv) transmitting the particulars of the transaction to a database of consumer purchasing behavior, and (v) automatically establishing an identity of an online shopping entity associated with the user computer for reference in future online activity performed by the online shopping entity. The monitoring of the email and the extracting of the transaction particulars may include operating a server computer to execute email reading software resident on the server computer. Alternatively, the email reading software may be resident on the user's computer.

### BRIEF DESCRIPTION OF THE DRAWINGS

FIG. 1 is a block diagram of an Internet-based shopping management system, showing a comprehensive online shopping management system (COSMOS) server computer.

FIG. 2 is a block diagram of the server computer of FIG. 1, showing a shopping management unit, a pair of shipping tracking units, and an email tracking unit.

FIG. 3 is a block diagram of the shopping management unit of FIG. 2.

FIG. 4 is a block diagram of an incoming shipping tracking unit shown in FIG. 3.

FIG. 5 is a block diagram of a returns shipping tracking unit shown in FIG. 3.

FIG. 6 is a block diagram of the email tracking unit shown in FIG. 3.

FIG. 7 is a block diagram of an online advertising system utilizing consumer purchase data collected via the shopping management unit of FIG. 2.

FIG. 8 is a block diagram of pertinent components of a search engine server shown in FIG. 7.

FIG. 9 is a block diagram of an advertising management server shown in FIG. 7.

FIG. 10 is a block diagram of components of the shopping management unit of FIG. 2, operative to collect consumer purchase data.

### DEFINITIONS

The term “transaction” as used herein denotes an event involving a transfer of goods or services and/or monetary funds. Where goods or services are exchanged for a monetary amount, the transaction may be characterized as a commercial transaction. However, some transactions may not involve the transfer of monetary amounts. For example, a transaction could be a barter activity or a consignment. A transaction may involve the transfer of funds in one direction without an accompanying transfer in the opposite direction, as in the case of a charitable contribution. A transaction may involve the transfer of funds in one direction with a transfer of one or more financial instruments (stocks, bonds, futures, options, warrants, calls, puts, etc) or other monetary amount (as in a currency transfer) in the opposite direction.

The word “automatically” or “automatic” is used herein to denote an activity, operation, function, or process that is executed by a computer or computer system without human intervention. For instance, a computer or computers performing a transaction management process as disclosed herein are programmed to carry out operations of monitoring screens displayed on a user's computer monitor while the user navigates the World Wide Web, determining whether the user is engaged in a transaction during the monitoring of each screen, collecting particulars of a transaction upon detecting that the user is engaged in a transaction, etc. Further automatic processes may include storing in a memory the particulars of the transaction and the particulars of multiple online transactions made by the user, and providing to the user a summary display of collected and stored information pertaining to the online transactions made by the user.

The term “automatically monitoring” is used herein to denote a software-mediated reading, scanning or examining of information on a computer screen to detect, for instance, whether a screen is one in which a user may be executing an on-line transaction. Thus, automatic monitoring pursuant to the instant disclosure does not contemplate the exercise of visual perception.

The term “automatically collecting” as in the phrase “automatically collecting particulars of a transaction” is used to denote a software-implemented extraction of data or information. This may involve accessing a computer RAM to transfer (and duplicate) information from one part of the RAM to another part of the RAM and optionally to permanent storage location in a nonvolatile computer memory.

The word “screen” is used herein to denote the collective textual and graphic information displayed on a computer monitor at any particular instance during computer usage. The term “screen” may also denote a changing pattern of information displayed on a computer monitor.

The term “screen scraper” is used in a broad sense herein to designate software for monitoring or scanning information displayed on a computer monitor and for extracting predetermined kinds of information from the computer. Screen scraper or data extraction software may interface with a computer at any practical or realizable nexus for accomplishing the monitoring and extracting functions. For instance, screen scraper software may take the form of a plug-in for browsers in order to monitor the information passing through or handled by the browser during Internet access. Alternatively or additionally, screen scraper software may function in part to monitor keystrokes on a keyboard. Information may be extracted from a RAM that temporarily holds the information displayed on a monitor screen.

The term “provider” is used herein to designate a party with whom a computer interacts on-line via the World Wide Web and the underlying global computer network known as the Internet in order to carry out a transaction. A provider may be a merchant of goods and/or services. A provider may be a financial service provider such as a stockbroker, a bank, a mutual fund, a commodities dealer, etc. or a provider may be a charitable institution

The terms “purchase data,” “purchasing behavior,” “purchase history information,” etc., are used herein to denote all aspects of online interactions between consumers or shoppers and merchants. These terms therefore include or cover such information as products purchased, the times at which purchases are made, shipping times, product returns, delays in receiving credit for product returns, damage to shipped goods, etc.

The term “online shopping entity” denotes herein a person or object with which it is possible to associate a history of online purchases. Typically, an online shopping entity is a person who uses a computer on the Internet or other network to make purchase of goods and/or services online. However, an online shopping entity as that term is used herein may designate an online computer that is loaded with browser plug-in software for monitoring purchases and extracting data for inclusion in a database of consumer purchasing behavior.

The word “product” as used herein by itself or as part of other terms, for instance, in the terms “product interest,” “product search,” “product purchase,” “product popularity information,” etc., refers broadly to anything for which consideration may be provided. Thus, the word “product” pertains to goods or services that are purchased. In addition, the word “product” may refer to a charitable donation situation. In the latter case, the product purchased may be viewed as the opportunity to help a valued cause.

### DETAILED DESCRIPTION

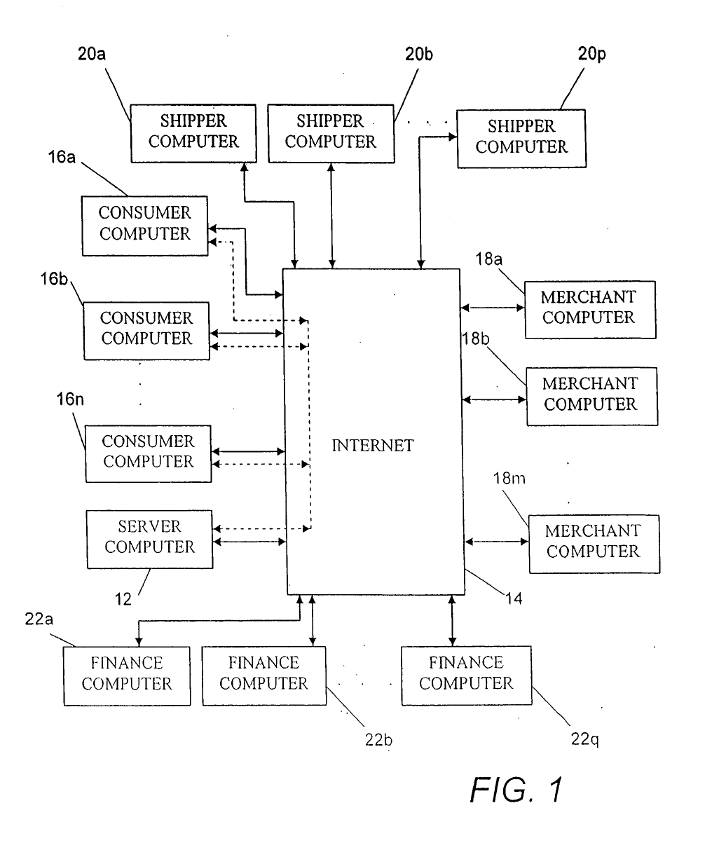

An online shopping management system illustrated in FIG. 1 is a computer system including at least one server computer 12 connected to the global computer network known as the Internet 14 for cooperating with consumer computers 16a, 16b, . . . 16n to monitor, track, manage, organize, and facilitate purchase transactions made by individual and/or corporate (business) consumers over the Internet. The purchase transactions involve communication between the consumer computers 16a, 16b, . . . 16n, on the one hand, and multifarious merchant computers 18a, 18b, . . . 18m, on the other hand. Merchant computers 18a, 18b, . . . 18m include all computers that cooperate with one another on the merchant side to implement sales transactions.

The online shopping management system of FIG. 1 further includes shipper computers 20a, 20b, . . . 20p and credit card/banking computers 22a, 22b, . . . 22q. Shipper computers 20a, 20b, . . . 20p provide information as to the status of shipments and may be used to enable merchandise returns. Financing or credit card/banking computers 22a, 22b, . . . 22q include computers owned by credit card companies, as well as bank computers that permit online purchases using debit card accounts and electronic funds transfer.

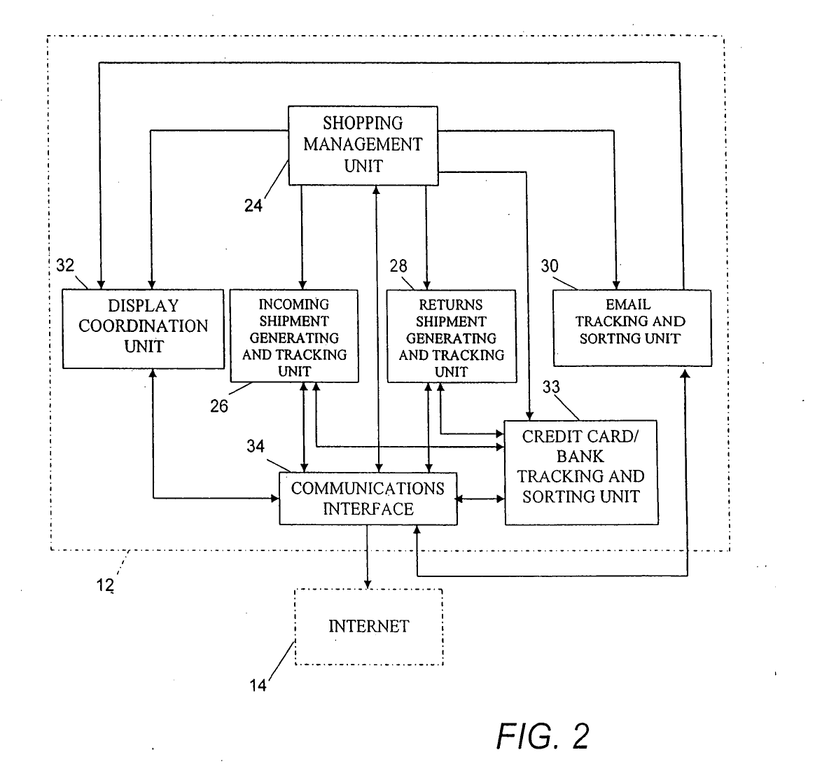

As discussed in detail hereinafter, the online shopping management system of FIG. 1, particularly server computer 12, is provided with software for assisting customers in recording and organizing information pertaining to purchases made by via consumer computers 16a, 16b, . . . 16n over the Internet 14 from a plurality of different merchants via a plurality of different websites maintained by respective merchant computers 18a, 18b, . . . 18m. This assistance is provided in the form of a personalized and customizable dashboard or control panel that is produced or reproduced in visually cognizable form on the monitors of consumer computers 16a, 16b, . . . 16n. As depicted in FIG. 2, the software on server 12 modifies generic digital circuitry of the server computer to define or create a shopping management unit 24, incoming shipment generation and tracking unit 26, a returns shipment generation and tracking unit 28, an email tracking and sorting unit 30, and a software-implemented display coordination unit 32. These units 24, 26, 28, 30, and 32 cooperate under the control and coordination of shopping management unit 24 to generate and provide the dashboard or control panel on the consumer computers 16a, 16b, . . . 16n. Server computer 12 also includes a software-implemented credit card/bank tracking and sorting unit 33 that holds user shopping information and simulates interfaces with shipping and payment tracking systems. Tracking and sorting unit 33 is connected to units 26 and 28, on the one hand, and to the Internet 14, on the other hand, for coordinating payments and refunds with credit card/banking computers 22a, 22b, . . . 22q.

As discussed in greater detail below, software-implemented shopping management unit 24 monitors consumer computers 16a, 16b, . . . 16n to detect shopping transactions as they are occurring. As discussed below, unit 24 may memorize or store shipping and payment particulars of the different customers for insertion into appropriate fields in an HTML or XML display screen. Shopping management unit 24 may carry out ancillary functions such as facilitating product marketing by utilizing user order data to provide targeted ads to the consumer computers 16a, 16b, . . . 16n via shopping management control panel or “dashboards” (see below).

Consumer computers 16a, 16b, . . . 16n are provided with web browser plug-ins, which are applications that run within the customer's web browser to assist in the capture of shopping related transactions and to assist in the process of filling shopping web forms. The plug-ins also communicate with the COSMOS server computer 12 to transmit thereto the customer's order data and save the order data state. The browser plug-ins may also store various user credit and debit card numbers and other payment account information, as well as passwords associated with such accounts. User IDs and passwords for various Web sites may also be stored and automatically entered in appropriate user fields of shopping sites on the World Wide Web.

Browser plug-ins or other screen-scraper software on consumer computers 16a, 16b, . . . 16n identify Web pages associated with online product purchases, including shopping home pages, product details pages, shopping cart pages, shipping and billing pages. From the shopping home page, a browser plug-in or other screen-scraper software is able to identify and extract a merchant name and logo. From a product details page, the browser plug-in or other screen-scraper software determines and retrieves product information. From a shopping cart page, the browser plug-in or other screen-scraper software detects and elicits shopping cart line items. From a shipping page, the browser plug-in or other screen-scraper software reads and stores shipping address and method, as warranted. From a billing or payments page, the browser plug-in or other screen-scraper software identified and extracts the billing method and address.

Browser plug-ins or other screen-scraper software may incorporate programming for classifying browsing patterns into states. A classification system may use a Bayesian classification scheme, a hidden Markov model, adaptive filtering (Karpov model), and/or a Viterbi algorithm. The inputs to the algorithms may be http requests, responses and emails, collectively “Data Capture Elements” or “DCEs.” DCEs are tokenized and represented in a vector format using Boolean expressions. For example, a DCE input with respect to the parameter selections electronics (yes), books (no), dvds (yes), categories (yes), wish (no), deals (no), gift (yes), releases (no), top (no), news (no), relations (no), great (no) would have a vector representation “101100100000.” The algorithms process these vectors to make decisions on the state of each DCE. Classificiation may be based on a single vector (Simple Module) or a chain of vectors (i.e., a browing pattern)(Markov module). For example, using a Simple Module pursuant to a Bayesian classification scheme, where the highest posterior value across all states yields the classification results:

$$\begin{matrix}1 & & electronics & 0.8 & & & & \\ 0 & & books & 0.7 & & & & \\ 1 & & dvds & 0.6 & & & & \\ 1 & & categories & 0.9 & & & & \\ 0 & & wish & 0.6 & & & & \\ 0 & & deals & 0.7 & & & & \\ 1 & \times & gift & 0.8 & \times & 0.3 & = & 0.621 \\ 0 & & releases & 0.6 & & & & \\ 0 & & top & 0.7 & & & & \\ 0 & & news & 0.1 & & & & \\ 0 & & relations & 0.2 & & & & \\ 0 & & great & 0.3 & & & & \\ & & & & & & & \\ \begin{matrix}Vector \\ Representation\end{matrix} & & \begin{matrix}Conditional \\ of State X\end{matrix} & & & \begin{matrix}Prior of \\ State X\end{matrix} & & \begin{matrix}Posterior \\ of State X\end{matrix}\end{matrix}$$

In another example using a Markov Module (Bayesian Classification+Markov Chain+Kalman Filter (adaptive filtering)+Viterbi), the state of a DCE based on a chain of DCEs is determined:

$$\begin{matrix} electronics & 0.8 & & & & & & & \\ books & 0.7 & & & & & & & \\ dvds & 0.6 & & & & & Http Response & & \\ categories & 0.9 & & Non Shopping & 0.7 \; 0.4 \; 0.1 & & & & \\ wish & 0.6 & & Shopping Home & 0.3 \; 0.2 \; 0.4 & & & & \\ deals & 0.7 & & Catalog & 0.4 \; 0.3 & & & & \\ gift & 0.8 & + & Product Details & 0.2 & + & Http Response & = & 0.423 \\ releases & 0.6 & & Search Results & & & & & \\ top & 0.7 & & Enter Shipping & & & & & \\ news & 0.1 & & & & & Http Response & & \\ relations & 0.2 & & Order Confirmation & & & & & \\ great & 0.3 & & & & & & & \\ & & & & & & & & \\ \begin{matrix}Conditional \\ of State X\end{matrix} & & & \begin{matrix}Transition Matrix \\ of Module X\end{matrix} & & & Chain & & \begin{matrix}Posterior of \\ Module X\end{matrix}\end{matrix}$$

Generally, algorithms require training before being able to process new information and properly classify it. Training results in finding the keyword space (pruning based on keyword relevance), the values for conditions for each module/state, and the transition probability matrices for Markov modules. The first step of training is to manually label DCEs with states. The second step is to use the collected DCEs and train the algorithms, conditionals, transition matrices and priors.

Consumer computers 16a, 16b, . . . 16n are further provided with email client plug-ins, namely, applications that run within the customer's email clients to assist in the capture of emails sent from merchants with whom the customer has engaged in one or more purchase transactions. The email client plug-ins provide order status updates to the COSMOS server 12 based on the information captured in the email. The COSMOS server 12 also provides email management capabilities, allowing the user to have COSMOS automatically filter emails from selected vendors from their primary email systems and send those emails into COSMOS. This will help the users reduce email clutter in their primary email systems and allow them to manage emails from vendors within the COSMOS system. Email plug-ins may use user feedback in the classification and extraction algorithms to enhance accuracy. In addition, the email plug-ins may enable the user to monitor whether the collected data is accurate and fix errors as warranted (this information may then used to enhance the accuracy of the algorithm).

Consumer computers 16a, 16b, . . . 16n are additionally provided with shopping management or desktop user interface software that cooperates with server 12 to enable the users to view their orders, order history, drill-down order information and other views summarizing their shopping activity. The shopping management or desktop user interface software also provides users with the ability to control COSMOS plug-ins settings and interact directly with COSMOS partner merchants.

Shopping management unit 24 of server computer 12 interacts with consumer computers 16a, 16b, . . . 16n and more particularly with the plug-ins and shopping management or desktop user interface software on those computers to implement the shopping management functions detailed herein. Those functions include the collection of order, merchant, pricing, payment, shipping, and order status information. Those functions may additionally include order cancellation, returns, and merchant email information; rewards points information; warranty information; and targeted marketing information. Software-implemented incoming shipment generation and tracking unit 26 issues commands to a shipping company to collect from any merchant specific items purchased online by the consumer, and to have such items delivered to the consumer's address. Unit 26 systemically sends the consumer's or COSMOS' unique charging number to the shipping company thereby charging COSMOS or the consumer for the requested shipping. In addition, unit 26 tracks the status of merchandise shipping from different merchants. Shipment generation and tracking unit 26 may periodically consult shipper computers 20a, 20b, . . . 20p via the Internet 14 to obtain updated information as to the status of customers' online purchases.

Software-implemented returns generation and tracking unit 28 issues commands to a shipping company to pick-up a return from the customer's house address or other address; alternatively, the system automatically generates a pre-paid return label that the consumer attaches to the return shipment and then she drops-off the return at an authorized drop-off point, such as a Post Office. To that end, unit 28 is connected via the shopping management or desktop user interface software on a user computers 16a, 16b, . . . or 16n to a user printer (not shown) for printing out shipping labels including, for instance, bar-type identification codes. In response to a request from a user computer 16a, 16b, . . . 16n, server 12 may submit and channel a pick-up request to a shipping provider. With respect to payment of the shipping costs, unit 28 may be connected to the Internet 14 via a communications interface 34 for purposes of contacting shipper computers 20a, 20b, . . . 20p to make automated payment or prepayment of the shipping charges.

In addition, returns shipment generation and tracking unit 28 tracks shipments to the different merchants of merchandise being returned by individual purchasers. Unit 28 may keep track of the locations of individual purchased items. As indicated, unit 28 may implement merchandise returns by contacting shipper computers 20a, 20b, . . . 20p via the Internet 14 to arrange for pickup and delivery of returns goods. Returns shipment generation and tracking unit 28 may communicate with shopping management unit 24 to update purchase information and to arrange for credits with the appropriate financial institutions via the respective computers 22a, 22b . . . 22q. Returns shipment generation and tracking unit 28 may additionally check for and update payment statuses of orders. To that end, returns shipment generation and tracking unit 28 may interact with external banking and financial systems computers 22a, 22b, . . . 22q to update the status of credit card authorizations and charges. Returns shipment generation and tracking unit 28 may further monitor that returns are received back by the respective merchants and that the merchants have posted credits to the user's payment account. Fraud protection features may be incorporated into the COSMOS system by giving the user access to generated credit card numbers to use in his/her shopping experience. The amount can then be billed to the customer through his/her profile in COSMOS (i.e. through one of the following channels: membership an Internet Service Provider program, supplied credit card number, supplied bank routing information, etc.).

Software-implemented email tracking and sorting unit 30 monitors email to and email from any given consumer computer 16a, 16b, . . . 16n pertaining to purchases made by the respective customer. The monitoring of email by email tracking and sorting unit 30 may include automatically reading the content of incoming email to determine whether the email contains confirmation numbers, shipping updates, or cancellation messages, i.e. information pertinent to transaction or purchase order status. Such information may be extracted out of the email and used to update a display of order status information. Email tracking and sorting unit 30 may also provide a message automatically to the user alerting him or her to the new order status.

In an alternative embodiment of a shopping management system, email tracking and sorting unit 30 is relied on exclusively to detect and identify completed consumer transactions. Thus, email is monitored and automatically scanned or read to determine first whether the email consists of a communication between a consumer computer 16a, 16b, . . . 16n and a merchant computer 18a, 18b, . . . 18m. Once an email communication is detected as concerning a transaction, the content of the email is mined to extract the transaction particulars.

A shopping management system as disclosed herein may be used to collect information as to individual consumers' buying habits, interests, and predilections. In addition, the information may be collated across transactions of different consumers to determine, for instance, preferences that consumers as a group have with respect to individual labels and merchants. As discussed below, the information as to individual consumer buying behavior may be used to select targeted advertising for presentation to consumers during their negotiation or “surfing” of the World Wide Web. The targeted advertising contemplated herein is derived from the overall purchase histories of the individual consumers and is typically unrelated to the content of the Web pages visited by the individual consumers and to the searches conducted by the consumers. The advertising may be displayed by searching services on the monitors or screens of consumer computers 16a, 16b, . . . 16n, together with the results of searches requested via the consumer computers.

Information collected by an online shopping management system with respect to the preferences that consumers have for different online merchants and for different brand-name products may be used by search engines to order the display of results pertaining to consumer product searches. Thus, when a person searches for a particular kind of product, the most popular sites may be displayed first, or otherwise identified in the search results, thereby providing the consumer with information as to the trustworthiness of and quality of service provided by the merchants.

As depicted in FIG. 2, software-implement display coordination unit 32 is connected to shopping management unit 24, incoming shipment generation and tracking unit 26, returns shipment generation and tracking unit 28, and email tracking and sorting unit 30 for generating on consumer computers 16a, 16b, . . . 16n display screens (e.g., a Web page) that list purchase transaction information, shipping status information, and email communications pertaining to online purchases. Display coordination unit 32 preferably organizes shopping summary information for presentation to the user in the form of a dashboard, control panel, or other format that facilitates use of the shopping management method or system to assist individual or business (corporate) consumers during and after purchases have been made. Display coordination unit 32 may communicate with consumer computers 16a, 16b, . . . 16n for purposes of customizing the dashboard or control panel to the particular users' preferences and inclinations.

Communications interface 34 distributes incoming information to shopping management unit 24, incoming shipment generation and tracking unit 26, returns shipment generation and tracking unit 28, and email tracking and sorting unit 30 and collects messages therefrom for communication to other computers via the Internet 14.

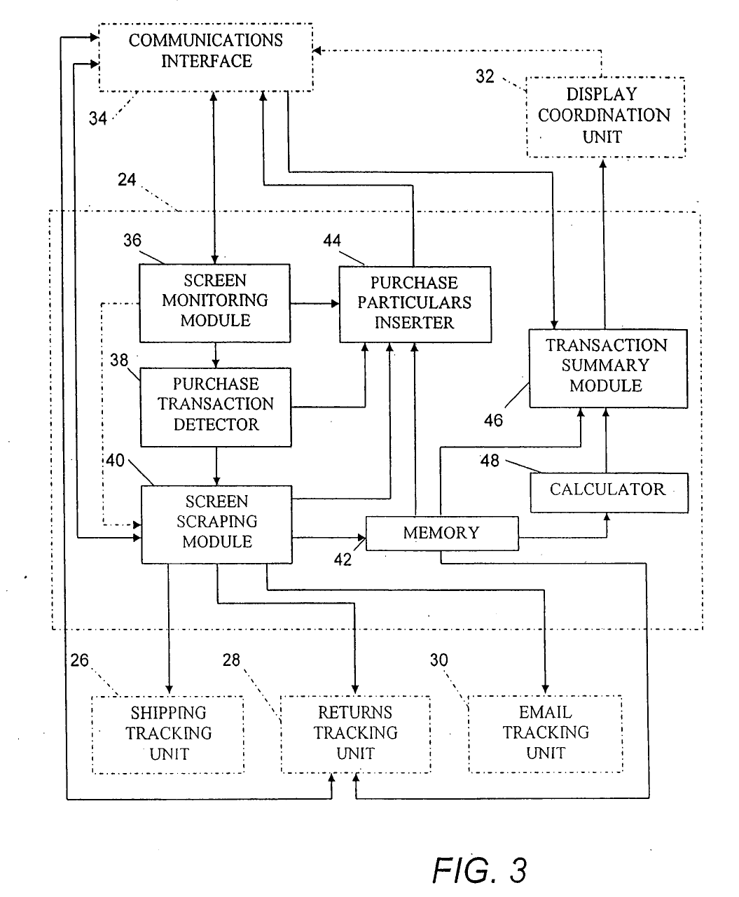

As illustrated in FIG. 3, shopping management unit 24 includes a software-implemented screen monitoring module 36 for automatically monitoring each screen displayed (for example, by Web browsers) on the monitors of consumer computers 16a, 16b, . . . 16n while the respective customer navigates the World Wide Web. Shopping management unit 24 further includes a software-implemented purchase transaction detector 38 operatively coupled to module 36 for automatically determining whether a customer is engaged in an online purchase transaction. Detector 38 determines from the format and the text of a World Wide Web page or other screen displayed on a consumer computer 16a, 16b, . . . 16n whether the customer is looking at a screen through which a purchase transaction can be made. Shopping management unit 24 also includes a screen-scraping or data extraction module 40, of conventional programming for extracting information from HTML or XML display screens, operatively coupled to detector 38 and optionally directly to communication interface 34 for automatically collecting particulars of a purchase transaction upon the determination by detector 38 that the customer is engaged in a purchase transaction. Screen-scraping module 40 stores in a memory 42 the particulars of the particular transaction, as well the particulars of other online purchases made by the customer. To carry out their respective functions, screen-monitoring module 36, detector 38, and screen-scraping module 40 may cooperate with browser plug-in software and shopping management or desktop user interface software on the respective user computers 16a, 16b, . . . 16n.

Shopping management unit 24 additionally includes a software-implemented module 44 that is connected to purchase transaction detector 38 and screen-scraping or data extraction module 40 for collecting shipping and payment particulars of the different customers. Module 40 communicates with memory 42 for storing therein customer names and one or more shipping addresses of each customer, for example, a home address and a business address, and for storing, for each customer, one or more credit or debit card numbers or electronic funds transfer accounts and passwords. Module 44 is connected directly or indirectly to communications interface 34 for inserting a customer's shipping and payment particulars into appropriate fields in an HTML or XML display screen, with the understanding and consent of the customer. Thus, the customer need not enter the shipping and payment particulars for each individual purchase made via the Internet 14.

Screen scraping or data extraction module 40 of shopping management unit 24 may act in particular to detect and record a completed check-out screen after a purchase has been made and a confirmation is displayed. Module 40 works mainly on the confirmation screen to “screen-scrape” the desired information. In addition, module 40 may extract the specific forms and formats of each and every merchant from whom the consumer purchases goods and/or services. Module 40 stores the forms and formats in memory 42, for subsequent recognition, together with the personal information input by the user or consumer in the entry fields on the forms. This information is then accessible by purchase particulars inserter 44 upon a subsequent recognition by modules 40 and 44 of a previously stored form and format. Thus, subsequent shopping is facilitated since a customer will not have to input information on a variety of forms every time she goes to different merchants. The recordation of forms and formats by module 40 in memory substantially enhances accuracy and reliability in the insertion of purchase particulars including user IDs and passwords on check out screens.

Shopping management unit 24 additionally includes a software-implemented transaction summary module 46 for providing to consumer computers 16a, 16b, . . . 16n respective summary displays of collected and stored information pertaining to the online purchases made by the respective customers. Transaction summary module 46 may organize the purchase information according to different sorting schemes, at the option of the customer. For instance, purchases may be sorted chronologically or by merchant, type of item or service, cost, shipping method or shipper, etc. The type of item or service may be divided into broad categories such as food, clothing, transportation, telephone and communications, entertainment, business, etc. More specific categories may be included as well. Thus, the entertainment category may be subdivided into electronic goods, video rentals, theater tickets, sports tickets, etc. The individual customers may change from one sorting scheme to another, upon request.

Transaction summary module 46 may be coupled to a generic calculator 48 in server 12 for obtaining therefrom the total costs of various groupings of purchased goods and services. Thus, module 46 may request from calculator 48 the total amount spent on purchases made in a particular month, or the total amount spent on food during a specified period, or the total amount of shipping costs, etc. Transaction summary module 46 is coupled to display coordination unit 32 which organizes and formats the summary information from module 46 for display on the individual consumer computers 16a, 16b, . . . 16n.

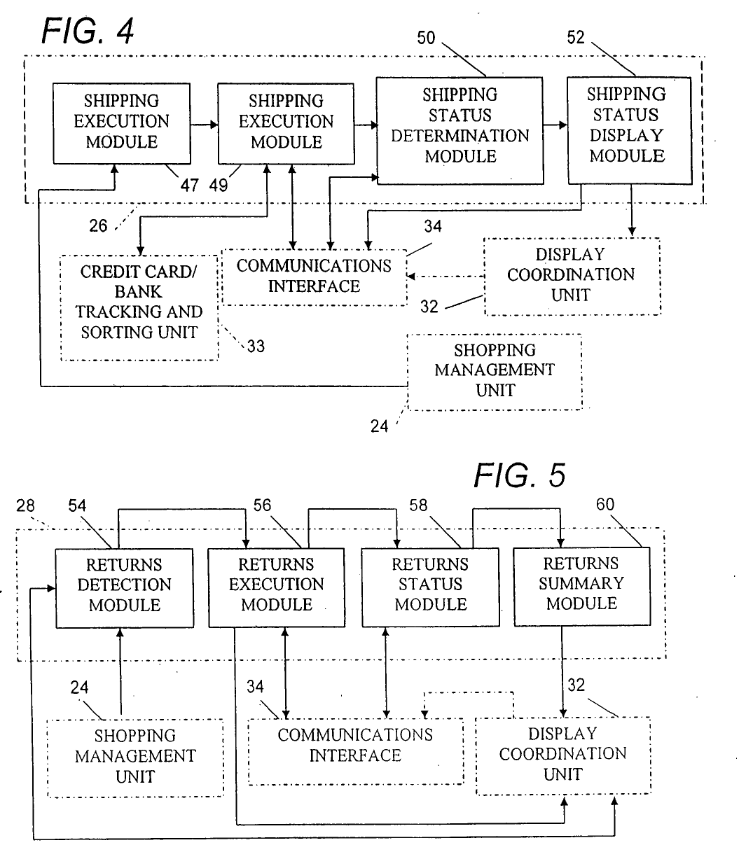

As depicted in FIG. 4, incoming shipment generation and tracking unit 26 includes a programming-implemented shipping detection module 47 linked to shopping management unit 24 and particularly to screen-scraping or data extraction module 40 or memory 42 thereof for identifying purchases that have been made. A programming-implemented shipping execution module 49 is coupled to detection module 47 for consumer selection of which shippers are to be utilized to convey the purchased goods. Shipping execution module 49 is connected to the Internet 14 via communications interface 34 for communicating with shipper computers 20a, 20b, . . . 20p to arrange for shipments. Shipping execution module 49 may be operatively connected to credit-card/bank tracking and sorting unit 33 for facilitating payment of shipping charges. Shipping execution module 49 is tied to a programming-implemented shipping status determination module 50 in turn connected to the Internet 14 via communications interface 34 for contacting shipper computers 20a, 20b, . . . 20p to periodically monitor the status of incoming purchases. Module 50 is connected to a programming-implemented shipping status display module 52 included in incoming shipment generation and tracking unit 26 for collecting and collating shipment information pertinent to respective customers; purchase transaction. Module 52 cooperates with display coordination unit 32 to provide the customer or user with information pertaining to shipping status of purchased items.

As depicted in FIG. 5, returns shipment generation and tracking unit 28 incorporates a programming-implemented returns determination module 54 operatively linked to display coordination unit 32 and to communications interface 34 for monitoring consumer computers 16a, 16b, . . . 16n for requests made by customers to return purchased merchandise. Returns detection module 54 is operatively linked to shopping management unit and more particularly to memory 42 thereof for obtaining information about the purchased merchandise to be returned. Returns shipping generation and tracking unit 28 further incorporates a programming-implemented returns execution module 56 tied to shipping status determination module 54 and to communications interface 34 for contacting merchant computers 18a, 18b . . . 18m and shipper computers 20a, 20b, . . . 20p, as warranted, to carry out returns ordered via consumer computers 16a, 16b, . . . 16n. Returns execution module 56 may be operatively connected to credit-card/bank tracking and sorting unit 33 (see FIGS. 2 and 4) for facilitating the crediting of funds from merchants on returned goods and for facilitating the payment of shipping charges on returns. In addition, returns execution module 56 may be operatively linked to a printer (not shown) for printing out shipping labels including, for instance, bar-type identification codes. Module 56 may arrange for prepayment of the shipping costs via the Internet 14 and communications interface 34.

As further depicted in FIG. 5, returns shipment generation and tracking unit 28 also incorporates a programming-implemented returns status module 58 operatively linked directly or indirectly to communications module 34 for periodically monitoring the status of shipments of returned merchandise, to the extent that status information is available on shipper computers 20a, 20b, . . . 20p. A returns summary module 60 in unit 28 is operatively linked to display coordination unit 32 for providing updated shipping status information to consumer computers 16a, 16b, . . . 16q.

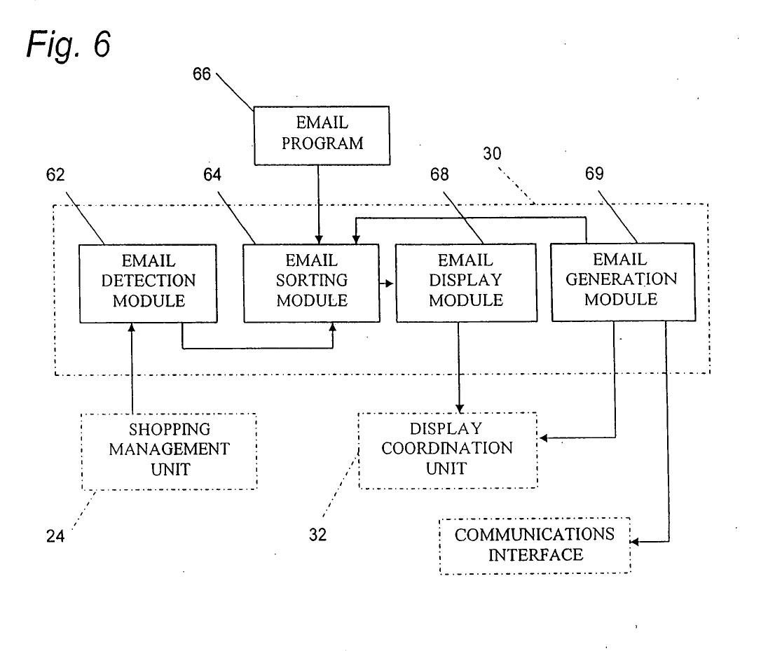

FIG. 6 shows details of email tracking and sorting unit 30 (FIG. 2). In particular unit 30 includes a programming-implemented email detection module 62 operatively coupled to shopping management unit 24 and particularly to screen-scraping or data extraction module 40 or memory 42 thereof for detecting the names of merchants from whom purchases have been made. Unit 30 further comprises an email sorting module 64 operatively connected to detection module 62 and to an email program 66 on a respective consumer computer 16a, 16b, . . . 16n for detecting email messages to and from different merchant computers 18a, 18b, . . . 18m involved in the individual customer's purchase (and returns) transactions. Sorting module 64 extracts information from the email program pertaining to online purchases and sorts that information in accordance with one or more sorting schemes selectable by the individual user or customer. The information extracted by sorting module 64 may particularly include information pertaining to order confirmation, shipping status, and order cancellation status such as order confirmation numbers, shipper identities, shipping numbers, shipping dates, shipping costs, and order cancellation numbers and dates. The extracted information may be transmitted to display coordination unit 32 to update the transaction and purchase order information organized and communicated to the user. Additional sorting of email messages may be made according to merchant, product type, date, etc. Sorting module 64 is connected to an email display module 68 in turn cooperating with display coordination unit 32 for displaying the extracted and sorted email data on the individual consumer computers 16a, 16b, . . . 16n.

In the extraction and sorting of transaction and purchase order information, email tracking and sorting unit 30 must be compatible with in at least one email program, e.g., Microsoft Outlook, and have an ability to intercept and parse new incoming email in that email program. Email tracking and sorting unit 30 implements a classification algorithm that identifies whether an email is incoming from an online merchant/service provider where the customer engaged in a transaction. Email tracking and sorting unit 30 incorporates a data extraction and matching engine that can match customer orders/transaction activity to the email contents and update order statuses and other data accordingly.

If these functions of email tracking and sorting unit 30 are performed on a user computer 16a, 16b, . . . 16n, the user computer communicates with server 12 to obtain order information to be used by the classification and data extraction algorithms and push order/transaction updates. On a user computer 16a, 16b, . . . 16n, these functions may be performed by an email email plug-in. For instance, the plug-in identifies email originating from a merchant with whom the user placed a pending order (based on the state saved in server 12 and other heuristics). The plug-in may inform server 12 to change the state of an order from “placed” to “confirmed.” The plug-in picks up the relevant information and shipping tracking number from the email and associates it with the customer order.

Email tracking and sorting unit 30 may send email notifications to user computers 16a, 16b, . . . 16n informing the respective users of order status changes has changed from “confirmed” to “shipped.”

As a backup, email tracking and sorting unit 30 may check the user's email on a regular basis for order confirmation emails to capture new orders that were not captured using desktop capture. Such order may have been placed, for instance, by telephone or other route. If a new order is found, email tracking and sorting unit 30 extracts the same order information as the browser order capture. Checks by email tracking and sorting unit 30 supports all email checking protocols including POP, IMAP and HttpMail. The user has to provide the proper information such as email sign-on info as well as email server address.

A user preferably has the ability to control email plug-in settings. The user is promptly notified, using taskbar pop-ups, about actions the email plug-in is undertaking. The email intercept and data extraction features may be disabled at the user's option.

Email tracking and sorting unit 30 may additionally include email generation and transmission capabilities, carried out by a module 69. Module 69 is connected to the Internet 14 via communications interface 34 and, in response to user commands, sends emails to origination points. Unit 30 may store all received and sent emails for fast and easy communications. Consumers can choose to receive reminders and other information from merchants.

The online shopping management system described hereinabove implements an electronic shopping method wherein screen monitoring module 36 of shopping management unit 24 automatically monitors each screen displayed on a user's computer 16a, 16b, . . . 16n monitor while the user navigates the World Wide Web. Purchase transaction detection module 38 automatically determines whether the user is engaged in a purchase transaction during the monitoring of each screen. Screen-scraping or data extraction module 40 automatically collects particulars of a purchase transaction upon detecting that the user is engaged in a purchase transaction and storing the particulars of the transaction in memory 42. For multiple purchases made by multiple users via respective consumer computers 16a, 16b, . . . 16n, screen-scraping module 38 stores particulars of the purchases in memory 42. The collected and stored particulars for each online purchase made via consumer computers 16a, 16b, . . . 16n may include an identification of a type of consumer or business item purchased, an identification of a seller or merchant of the consumer or business item purchased, and a purchase price. The purchase particulars stored by memory 42 may additionally include, for each online purchase made by the user, shipping fees and taxes paid.

Transaction summary module 46 provides to the user a summary display of collected and stored information pertaining to the online purchases made by the user. Module 46 organizes the displayed information according to any one of a plurality of different sorting schemes. The different sorting schemes may be by type of item purchased, by seller, and by price. The different sorting schemes may optionally include listing displayed information by shipping fees and taxes paid.

The purchase transaction summary displays on the monitors of consumer computers 16a, 16b, . . . 16n may include information pertaining to shipping status of purchased items. This information is collected, collated, and presented by shipping generation and tracking unit 26. The displayed shipping status may include shipment method and expected delivery date. The displayed status may further include information about delays and shipping problems. As indicated above, the shipping status information is typically obtained from the shipper computer 20a, 20b, . . . 20p via the Internet 14 and is sorted and organized by shipping status display module 52 for presentation to the respective users via computers 16a, 16b, . . . 16n.

The summary display provided by display coordination unit 32 may include interactive options for the user. For example, as discussed above, returns shipping generation and tracking unit 28 executes return options selectable by the user in response to the display of possible options by returns execution module 56 in cooperation with display coordination unit 32. Returns status module 58 displays to the user information tracking the status of the return shipments.

To reduce shipping costs for users of the COSMOS system, online buyers may be aggregated into a singular unit or “client” group. This aggregation may also facilitate the logistics of shipping, for example, by combining shipments to or from different users where the shipments are being sent to the same or proximate locations. Pursuant to this aggregation agenda, the “shipper” is not the merchant but is instead the customer. The customer essentially sends his or her shipper to pick the merchandise up and deliver it. So, for example, a user of the shipping management system may utilize it to electronically signal a designated shipping company to pick up a purchased item at the user's home address or at the address of the merchant, and deliver it to the user's address or the merchant's address, and the system will electronically submit to the shipping company a unique billing number assigned to the user so that the user becomes responsible for managing the shipment and return of his purchase and is responsible for paying the cost of such shipment which will be automatically billed by the system to his credit card.

The comprehensive online shopping management method performed by server computer 12 is performed while the user surfs the Web, making purchases at the Web sites of different merchants. Typically, at least some of the online purchases are made by the user after conducting a Web search using a search engine.

Server computer 12 may perform the additional service of providing credit card alerts to users. Alerts pertain to the charging or crediting of the users' credit or debit cards. Thus, where user returns a purchased item to a merchant, the system will track the return of such item and alert the user's credit card provider that a credit is due from the merchant. The system will then inform the user when such credit is received.

Credit card data is incorporated when charges are made, and when credits are received for returns. Normally, one does not know when he or she receives a credit for a return and has to wait and see the next month's credit card statement. The COSMOS system may alert users by retailer exactly when credit is received.

A shopping services provider, that is, a company carrying out the purchase tracking methodology described hereinabove, communicates with customers via the Internet 14 and assists customers in recording and organizing information pertaining to purchases made by the customers over the Internet from a plurality of different merchants via a plurality of different websites. In addition, that company may extend to the customers one or more and preferably three of more of the following: (i) providing credit card alerts to the customers via Internet 14, (ii) tracking merchandise shipments, (iii) providing insurance against incomplete merchandise receipt, (iv) providing an extended return period, providing a guaranteed return period, (v) providing an extended warranty period, (vi) providing a guaranteed warranty period, (vii) providing insurance on returned merchandise, (viii) providing frequent buyer points, (ix) providing gift cards, and (x) providing an alternative dispute resolution procedure. Users are aggregated into a single cohesive “client” or “group” so that the users become an entity whereby each user can organize, control, manage, and pay for, his own individual shipping and return functions as they relate to items purchased and recorded on the system.

Additional services extended to customers in an on-line shopping management system pursuant to the present invention may include shipment holding features, for example, holding users' purchases while the users are on vacation. Another service is to provide, to selected merchants, additional shipping methods such as local store pick-ups. A selectable setting may enable or require shopping management unit 24 of server computer 12 to automatically email user computers 16a, 16b, . . . 16n when there is a change of a previously identified nature detected in the status of the respective user's purchases. For example, a shipping status message may be automatically dispatched when an order previously placed by a user arrives at a pick-up location.

It is to be noted that the system and methodology described hereinabove may be carried out in different ways. Pursuant to one scenario, consumer computers 16a, 16b, . . . 16n download software which tracks the respective users' online purchasing behavior and then sends data back to COSMOS server 12 for translation onto the consumers' Web pages on the COSMOS system. Alternatively, consumers essentially go shopping “through” the COSMOS system when they hit the shopping buttons on their ISP providers such as Yahoo! and aol. In that case, there is an imbedded link to COSMOS system at that level. The system becomes activated when the user is directed to “shop” through the system's computers 12, so that whenever the user goes on the World Wide Web he invisibly takes along with him the system's tracking and recording devices.

Accordingly, one of ordinary skill in the art will recognize that various functions of the COSMOS system may be performed on consumer computers 16a, 16b, . . . 16n and other functions performed on server computer 12. Thus, various components of server computer 12 illustrated in FIGS. 2-6 may be implemented in whole or in part in software loaded onto consumer computers 16a, 16b, . . . 16n. Alternatively or additionally, various components of server computer 12 may be distributed throughout one or more server computers that cooperate via the Internet or a private hardwired network.

Where users' personal information (names, addresses, credit or debit card numbers, purchases, email, etc.) are stored in some form in memory 42 of a server computer 14, access to the consumers' COSMOS pages, sorted by retailer, is obtained only after entry of a PIN or other code, and a password. Thus, the user is assisted in enjoying the shopping experience without annoying intrusions.

The online shopping management system can be used to track requests for catalogs, samples, swatches, and other product information by vendor. Thus, any transactions made over the Web may be tracked and summarized for display. As indicated elsewhere herein, the COSMOS system can equally apply to services purchased online.

The online shopping management system described hereinabove is equally applicable to businesses as well as individuals. Any “person” who orders items or services over the internet for free or for payment can use the system and manage their activity through the system. Thus, the word “user” is used herein to designate artificial or legal entities, as well as natural persons.

Many of COSMOS functions operate independently of the seller or provider of the items or services. In most cases the data is collected with the consent of the shopper, not the shipper or provider.

With respect to the shipping and return functions performed by the computer modules shown in FIGS. 4 and 5, the COSMOS system allows the consumer (individual or business) to become the shipper of her own items as opposed to the conventional process where the shipper is the merchant or seller. The COSMOS company may provide its users or customers with pre-negotiated shipping rates by accumulating all COSMOS shoppers into a group for bargaining purposes. Then when a user or customer buys something over the Internet 14, server computer 12 sends an electronic signal to a shipping computer 20a, 20b, . . . 20p on the user's behalf and with the user's shipping account number for billing purposes, asking the shipping company to go pick up the merchandise from the respective merchant's address and send it to the user's home or business. Similarly, the returns process works the same way—the user can send the return back by bringing the shipping company to her house to collect it at rates negotiated for her by the COSMOS company.

The shopping management or desktop user software on user computers 16a, 16b, . . . 16n may run in an offline mode and synchronize data and request order changes on connection (in the way the Outlook mail program works in an offline mode).

In order to implement protection against credit card fraud, the shopping management or desktop user interface software on user computers 16a, 16b, . . . 16n is configured to cooperate with shopping management unit 24 and credit card/bank tracking and sorting unit 33 to utilize one time credit card numbers for discrete purchases over limited periods of time and/or with limited numbers or merchants.

The COSMOS server 12 can interface to any search engine and help, complete, perfect, control, and manage the output of the search which leads to an online transaction. The COSMOS server 12 may enable a user to access and manage their on-line shopping not only from home computers but from any computer 16a, 16b, . . . 16n connected to the Internet 14. Users are thus able to see orders captured by COSMOS, view the status of the orders, change settings and request changes and services the same way the users can do that from their COSMOS desktop control panels.

It is to be noted that the COSMOS system described herein may also track other kinds of financial transactions other than purchases of goods and services. For instance, where an individual user engages in charitable contributions, the COSMOS system may track the amounts and dates of the donations, as well the charities and other not-for-profit organizations that receive the funds. The charities may be organization by kind and amount donated, etc.

Even if no money exchanges hands, the COSMOS system may be used to track amounts or numbers and kinds of goods and services which are being transferred. This functionality can be useful in consignment arrangements as well as in the provision of sample goods and services.

The COSMOS on-line shopping management system may additionally include ancillary on-line services such as instant messaging, whereby users can share their positive and negative shopping experiences with friends and family.

Many of the functions performed by server computer 12 may be performed in whole or in part by browser and email plug-ins and/or by shopping management or desktop user interface software on user computers 16a, 16b, . . . 16n. Thus, the various data collection and sorting functions may be performed centrally or locally or in a portioned load distributed among one or more server computers 12 and user computers16a, 16b, . . . 16n. Where shopping management operations are carried at least in part by user computers 16a, 16b, . . . 16n, the functional blocks depicted in FIGS. 2-6 are located in whole or in part on the user computers, with communications functionality as warranted for cooperating with one or more server computers 12. In a distributed processing system, the proportion of operations carried out by various components of the system of FIG. 1 may vary from moment to moment in accordance with instantaneous load requirements and processor availabilities.

As indicated above, the shopping management system of FIGS. 1-6 may be used to collect data pertaining to the buying habits of individual consumers shopping online via computers 16a, 16b, . . . 16n. This data may be used, as described in detail hereinafter, to present, to the users of consumer computers 16a, 16b, . . . 16n, online advertisements targeted to the individual consumers buying habits, tastes, interests and preferences, apart from the immediate online behavior of the consumers, e.g., apart from the content of search requests made via consumer computers 16a, 16b, . . . 16n, and apart from the content of Web pages being viewed by the users.

In addition, the shopping management system of FIGS. 1-6 may be used to collect sales statistics pertaining to individual online retailers and brands of different kinds of goods. These statistics may be used to provide online shoppers with any information that may be derived from data extracted as to purchases made online. Such information may include, for example, the popularities of different online retailers and/or the popularities of different consumer items. Other kinds of information that may be transmitted to online user computers include other kinds of products frequently purchased by those who purchase a given product, products that have been purchased during any particular month, merchants who provide certain goods at the lowest prices after rebates and discounts, brands that are most frequently returned to the sellers, brands of which people make multiple successive purchases, merchants with the quickest shipping times, merchants with free shipping, etc.

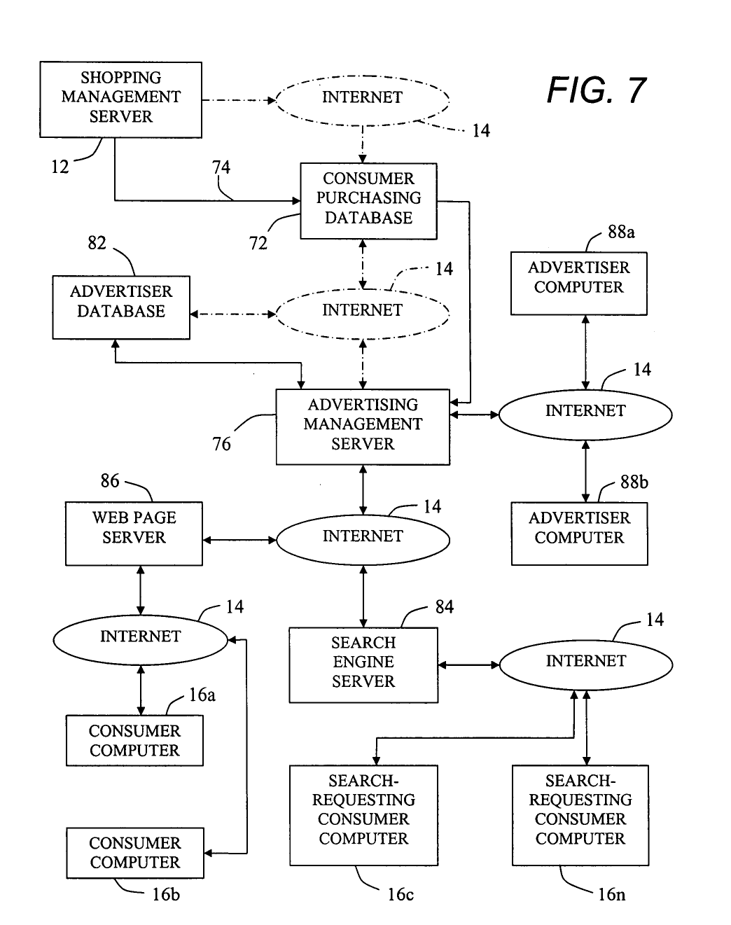

As illustrated in FIG. 7, a system for using the collected information includes a purchasing behavior database 72 operatively connected to shopping management server 12 either through the Internet 14 or directly via a dedicated bus 74. Database 72 stores data pertaining to the buying habits of individual consumers shopping online via computers 16a, 16b, . . . 16n. Database 72 also stores data collated across consumers and pertaining to sales by individual online retailers, both as a whole and with respect to individual goods and brands of goods.

Database 72 is accessed via an advertising management server 76 either via the Internet 14 or directly via a dedicated data bus 78. Server 76 is also connected via the Internet 14 or a dedicated bus 80 to an advertisement database 82. In response to requests arriving from search engine servers 84 and other Web page servers 86 over the Internet 14, advertising management server 76 accesses database 72 to determine the buying habits, interests, etc, of individual consumers (corresponding to respective user computers 16a, 16b, . . . 16n) and selects from advertisement database 82 online advertisements that conform to the buying habits, interests, etc., of the individual consumers. The advertisements are transmitted to the requesting search engine servers 84 and other Web page servers 86 for relay to respective consumer computers 16a, 16b, . . . 16n for display on the consumer computers' monitors together with search results or Web pages for viewing by the consumers.

In accordance with consumer purchasing behavior stored in database 72, advertising management server 76 may also provide recommendations as to rewards and free gifts to be offered to the users of user computers 16a, 16b, . . . 16n. Database 72 enables advertising management server 76 to select rewards and gifts in the same way that the server selects advertisements, that is, by comparing the purchase behavior of individual users with the collective purchase behavior of other users. Where there is a sufficient degree of overlap between the purchasing behavior of an individual online shopping entity and the purchasing behavior of a group of other online shopping entitites, purchases made by the group may be used to predict potential purchasing interests of the individual.

Shopping management server 12 and advertising management server 76 may be implemented by separate computers. Alternatively, as indicated by phantom box 88, servers 12 and 76 may be implemented by a single computer, with databases 72 and 82 being segregated parts of a common memory connected to the single computer.

Advertising management server 76 may be connected to advertiser computers 90a, 90b . . . via the Internet 14, for obtaining advertisements (graphics, copy, sound bites, etc) for inclusion in database 82. Alternatively or additionally, the advertisement contents of database 82 may be input directly via input peripherals (not shown) connected to server 76.

Search engine server computer 84 is connected to the Internet 14 in part for maintaining a portal thereon. Server 84 is programmed to (1) conduct searches for information via the Internet in response to search requests or queries from user computers 16a, 16b, . . . 16n, (2) transmit, to the user computers, results of respective searches conducted via the Internet, and (3) transmit, to the user computers, advertisements selected from advertisement database 82 by advertising management server 76 in accordance with buying habits of individual users as codified in purchasing behavior database 72. The advertisements are transmitted to user computers 16a, 16b, . . . 16n together with the search results for simultaneous display with the search results on user computer monitors. The advertisements are selected in accordance with buying habits of individual users, independently of search queries and independently of the results of the searches.

In a modified online advertising system, screen scraping or data extraction module 40 communicates with advertising management server 76 for receiving therefrom advertisements and other consumer oriented information for display on monitors of user computers 16a, 16b, . . . 16n. Screen scraping or data extraction module 40 may be configured to alert advertising management server 76 as to when user computers 16a, 16b, . . . 16n are engaged in product searching and/or purchasing activities, so that advertising management server 76 may provide the user computers with ancillary consumer data such as (a) the relative popularities of different online merchants with respect to the sales of particular consumer products or services, (b) the relative popularities of different brands, (c) the relative popularities of different styles or colors of a particular kind of consumer product, or (d) other products in which the individual online shoppers may be interested.

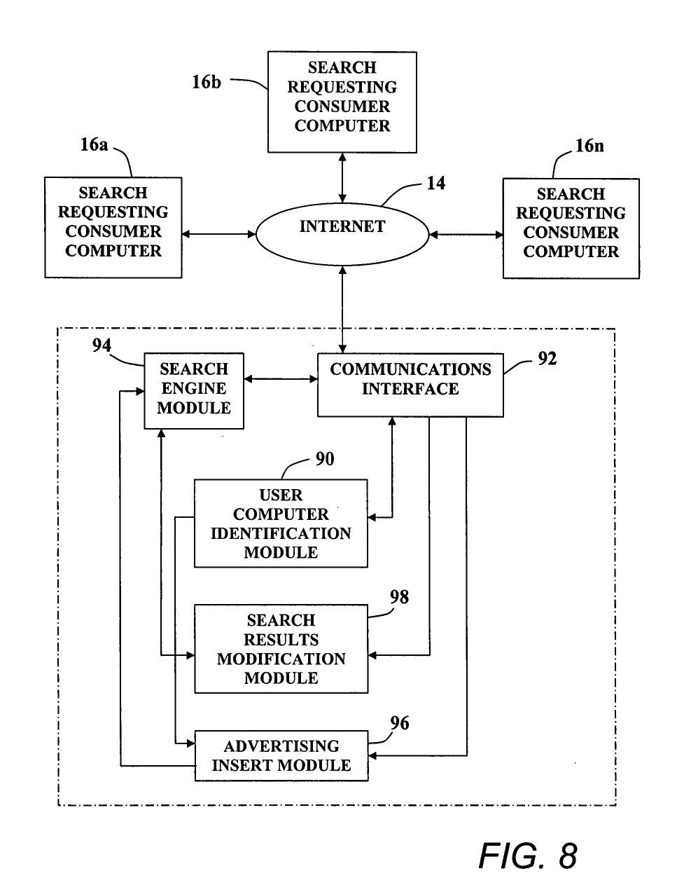

The system of FIG. 7 includes means for determining, for each search request or query submitted to search engine server 84 or Web page server 86, an identity of the respective user computer 16a, 16b, . . . 16n originating the search request or query. For instance, as illustrated in FIG. 8, search engine server 84 or Web page server 86 may be provided with a user computer identification module 90 for locating computer or user identification information on the user computers 16a, 16b, . . . 16n. Module 90 may be implemented by generic digital processing circuits as modified by programming to carry out the identity locating and reading function. Module 90 is connected to the Intent 14 and from thence to user computers 16a, 16b, . . . 16n via a communications interface 92 in the respective server 84 or 86. Module 90 is also connected to advertising management server 76 either directly (e.g., server 84 and 76 implemented by common computer) or via the Internet 14 for conveying thereto the identities of user computers 16a, 16b, . . . 16n that are engaged in searches via search engine server 84. Module 90 is connected to a search engine module 94 that carries out searches in response to search requests arriving from computers 16a, 16b, . . . 16n via communications interface 92.

The computer or user identification information may be placed in computer memory (typically on a disk drive) by the same browser plug-in that monitors online purchases and extracts data relevant thereto for transmission to purchasing behavior database 72. The identity information may include a designation peculiar to the user computer, but may additionally include one or more user names and addresses extracted by the browser plug-in software during online purchase activity.

As further illustrated in FIG. 8, servers 84 and 86 each include an advertising insert module 96 connected to advertising management module 76 via the Internet 14 (or directly) and communications interface 92 for receiving advertisements selected by server 76 in accordance with the determined identities of user computers 16a, 16b, . . . 16n and the respective purchasing habits as stored in database 72. Advertising insert module 96 may be implemented by generic digital processing circuits as modified by programming to carry out the advertising insert function. Advertising insert module 96 is connected to search engine module 94 for enabling the insertion of targeted advertisements in search results or other Web page displays on the user computer monitors.

In the modified online advertising system, advertising management server 76 may itself incorporate user computer identification module 90 and advertising insert module 96 (FIG. 8). In this modified system, the selection and transmission of advertisements by advertising management server 76 to user computers 16a, 16b, . . . 16n is triggered by signals from the user computers to advertising management server 76 indicating that the user computers are online and available for the receipt and display of modeled advertisements and merchant and product popularity data.

As additionally illustrated in FIG. 8, search engine server 84 (but not Web page server 86) may include a search results modification module 98 connected to advertising management module 76 via the Internet 14 (or directly) and communications interface 92 for receiving from server 76 sales activity information identifying, for instance, merchants that sell significant quantities of consumer products being searched online by user computers 16a, 16b, . . . 16n. Search results modification module 98 is connected to search engine module 94 for receiving therefrom instructions pertaining to search requests. Search results modification module 98 may determine whether a search is for a consumer product and if so transmit a request to advertising management server 76 for merchant statistics pertaining to that product.

Search results modification module 98 may be implemented by generic digital processing circuits as modified by programming to identify product searches and to retrieve merchant sales statistics. Search results modification module 98 is connected to search engine module 94 in part for adding, to search results, information pertaining to merchant activity at least with respect to consumer goods identified in search requests. Search results modification module 98 and search engine module 94 may present the merchant sales activity information in any form. For instance, an indication may be made next to each merchant listed in a search results page as to the amount of sales activity experienced by that merchant with respect to the respective product or consumer item. Alternatively, a separate search list may be provided, for instance, in a column at the margin of the user's computer screen, where online merchants are arranged in an order of decreasing sales volume for the searched item. This statistical listing of merchant popularity may be supplemented by a statistical listing of merchant reliability, for instance, a separate listing of merchants in an order of increasing (or decreasing) number of product returns or proportions of purchased products that are returned.

In an alternative method for presenting merchant popularity and reliability statistics to the operators of user computers 16a, 16, b, . . . 16n, advertising management server 76 may itself incorporate program-modified circuitry for presenting to the operators of computers 16a, 16b, . . . 16n the merchant statistics. The merchant popularity and optional reliability lists may be provided on “message toast” windows or screen inserts displayed on the user computer monitors during the display of search results on consumer items or merchants. Such information on merchants may alternatively or additionally be displayed in pop-up or “message toast” windows or inserts when a user computer 16a, 16b, . . . 16n is on a merchant Web site, for example, looking at particular products of types of products. The pop-up window or message toast may display not only statistics regarding the particular merchant, but may present the popularities and reliabilities of other merchants for comparison. In addition, advertising management server 76 may provide the online users and potential shoppers with statistics as to related products, for instance, the popularities of different colors or styles of the product on the user's computer screen, or the popularities of different but related products. In this modified system, the selection and transmission of merchant and product popularity and reliability data by advertising management server 76 to user computers 16a, 16b, . . . 16n is triggered by signals from the user computers to advertising management server 76 indicating that the user computers are online and conducting a search or on a merchant Web site looking at consumer products.

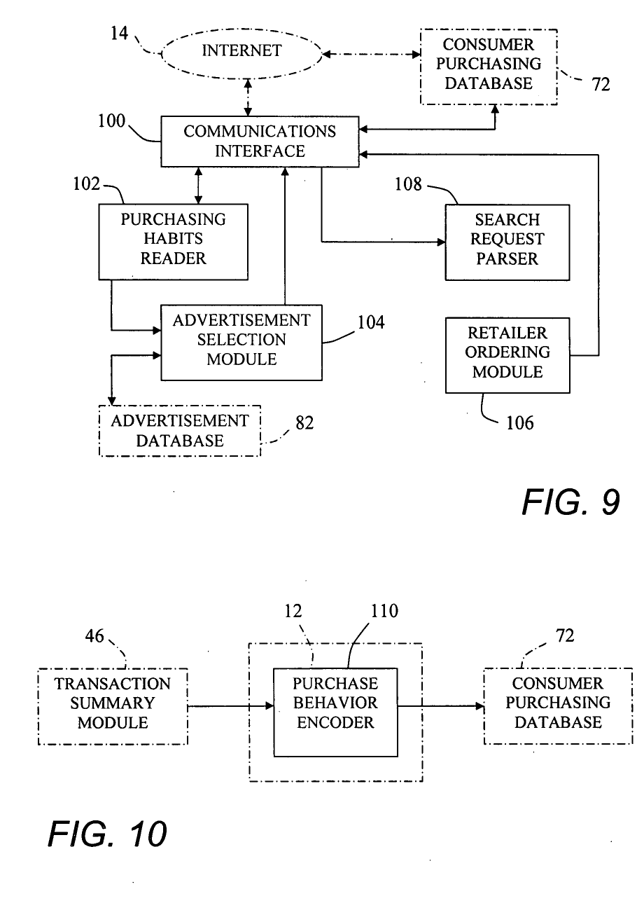

As depicted in FIG. 9, advertising management server 76 includes a communications interface 100 and a purchasing habits reader 102. Reader 102 is operatively connected via interface 100 and the Internet 14 to search engine server 84 and Web page server 86 for obtaining user computer identification information therefrom. In response to that identification information, reader 102 accesses database 72 via interface 100 to retrieve data identifying consumer buying habits, preferences, etc. Reader 102 is connected to an advertisement selection module 104 that accesses database 82 to select advertisements in accordance with consumer buying habit information. Advertisement selection module 104 then forwards the advertisements (or an identification of where those advertisements are located, to search engine server 84 and/or Web page server computer 86 for inclusion on Web pages (such as search results pages) to be displayed on respective user computers 16a, 16b, . . . 16n.

In an alternative advertising system described above, advertisement selection module 104 forwards selected advertisements directly to respective user computers 16a, 16b, . . . 16n for simultaneous display with Web pages displaying virtually any other kinds of information. As indicated above, the advertisements are unrelated to the primary content displayed on the monitors of user computers 16a, 16b, . . . 16n. To select advertisements from database 82, a particular user's purchasing habits are compared with the purchasing habits of other online shoppers as codified in database 72. Where there is overlap, the future consumer interests of the particular user are predicted from the online purchasing behavior of the mass of online shoppers who have purchased goods similar in part to goods purchased by the particular user. Thus, it may be that a user who has purchased golf equipment online may also have an interest in purchasing asset management software. Another user who has purchased jet skis online might also have an interest in after-market automobile accessories. As further depicted in FIG. 9, advertising management server 76 also includes a retailer ordering module 106 that accesses database 72 via communications interface 100 in response to a product search request. Product search requests are fielded by a parser module 108 connected to retailer ordering module 106 for inducing that module to obtain merchant sales activity information from database 72. Module 106 communicates with search results modification module 98 (FIG. 8) of search engine server 84. In an alternative configuration discussed above, module 106 may transmit merchant sales activity data directly to user computers 16a, 16b, . . . 16n for display on computer monitors together with consumer-product search results or merchant Web pages.

In providing search results to user computers 12a, 12b, . . . 12c or to other user computers not served by shopping management server 12 and its associated functionality, search engine computer 84 transmits, for at least some individual types of products searched, information pertaining to sellers of the individual types of products. The information pertaining to sellers of the individual types of products typically includes sales volume of different sellers (popularity data), either explicitly or implicitly via a classification scheme (e.g., four stars for high sales volume, one or no stars for low or insignificant sales volume, pertaining to a particular product category such as athletic shoes or, more specifically, Nike™ running shoes).

As shown in FIG. 10, shopping management unit 12 may include a purchase behavior encoder 110 operatively connected to transaction summary module 46 (FIG. 3) for culling consumer purchasing data from detected purchase orders. The same orders yield data on merchants' sales activity and particular products. These data are fed to database 72. Thus, purchase behavior encoder 110 monitors purchase activity of users conducted on the Internet 14 via respective user computers 16a, 16b, . . . 16n. Purchase behavior encoder 110 is characteristically implemented in the form of generic digital circuits of server 12 and of user computers 16a, 16b, . . . 16n modified by programming to extract consumer purchase data and to export that data to database 72. Purchase behavior encoder 110 interfaces or communicates with screen scraper software (as generally defined herein) on the user computers 16a, 16b, . . . 16n, to enable the data mining and exportation.

Advertising management server 76 may access database 72 in part for purposes of organizing, collating, condensing, and ordering the information contained therein both respect to individual consumers and individual online retailers and merchandisers. To that end, advertising management server 76 reads through information on purchases made through a common computer 16a, 16b, . . . or 16n to determine the most frequently purchased kinds of consumer items. Advertising management server 76 may collate, categorize and condense consumer purchase information in database 72 in conjunction with categories of advertisements as stored in database 82. Of course, at least some of this organizing, collating, categorizing, and condensing, of consumer purchase history information may be effectuated upstream of database 72, for instance, by shopping management software placed on user computers 12a, 12b, . . . 12n, alone or in cooperation with programming on server computer 12.

Data may be organized and stored in database 72 pursuant to different classification levels. Thus, consumer purchasing behavior may be organized by product categories first in broad fields such as transportation, information technology, domestic goods, entertainment, health, etc. Each broad class is then repeatedly subdivided until one reaches the level of specific goods, such as Adidas running shoes. Accordingly, the field of entertainment may be subdivided into vacations/trips, games, vehicles, performing arts, books, music, sports equipment, sports clothing, etc. Sports equipment is subdivided by specific sports such as football, baseball, downhill snowboarding, mountain bicycling, canoeing, etc. Each sport is subdivided by the types of equipment peculiar to that sport. Thus, baseball equipment includes outfield gloves, catcher mitts, first baseman gloves, bats, balls, helmets, catcher masks, etc. Baseball uniforms and caps as well as shoes may be located in a clothing category. Finally, you have the equipment divided by brands.

It is to be noted that the examples provided herein as to use of accumulated consumer purchase data are merely illustrative. There are myriad ways that consumer purchase data can be organized and statistically analyzed, not merely by merchant or product classification. One may organize by affinity to a type of offering, or by consumer demographics or psychographic parameters. Database 72 preferably has multiple layers of data sets.

The product purchases made via user computers 16a, 16b, . . . 16n may be collated and organized by the various product categories. Thus, a particular user may have an online purchasing history with concentrations of purchases in water skiing equipment and home barbecue accessories. A comparison with data on the purchasing behavior of other online shoppers who also purchase water skiing equipment and home barbecue accessories may reveal, for example, that such shoppers are also inclined to purchase vacations to Rio de Janeiro. Accordingly, when the particular user is online, modeled advertisements directed to that user might be directed to vacation packages to Rio de Janeiro, as well as to swimming suits and specialty cookware.

Shopping management server 12 and advertising management server 76 may be implemented by the same computer or computers as search engine server 84. Alternatively, as indicated above, these servers 12, 76, 84 may be realized as individual and distinct computers communicating withy each other either via dedicated buses or via the Internet 14.

Server 86 may be any computer connected to a computer network such as the Internet for maintaining an electronic site or page accessible via the computer network. As discussed above with reference to FIGS. 7 and 8, server 86 may be part of the online advertising system for presenting Web pages on user computer displays or monitors, together with advertisements (e.g., banner ads) selected in accordance with the long-term buying habits of individual users determined in accordance with purchases made over the computer network via the respective user computers 16a, 16b, . . . 61n. The advertisements are transmitted to the user computers together with the site or page for simultaneous display with the site or page on user computer monitors. (In an alternative system described above, advertisement selection module 104 may transmit advertisements directly to user computers 16a, 16b, . . . 16n for display simultaneously with Web site or pages from server 86.) Generally, a consumer's buying habits are determined from purchases made over an extended period of time, from days to weeks to months and even longer. If an individual online consumer frequently shops via the Internet, a shorter period of several days may be enough to adequately indicate shopping habits and preferences. In such cases, purchases made weeks or years ago may indicate a past interest, one that is evinced no longer by the particular consumer.

As noted hereinabove, advertising management server 76 selects advertisements from database 82 in accordance with consumer purchase history data in database 72. Database 72 is accessed pursuant to computer identification information from user computer identification module 94 of server 84 or 86. The advertisements are selected independently of search results determined by search engine server 84 and independently of Web page content distributed by server 86. The advertisements are transmitted to the user computers 16a, 16b, . . . 16n together with the search results from search engine server 84 or together with the site or page from server 86, for simultaneous display therewith.

In an alternative system described above, advertisement selection module 104 may transmit advertisements directly to user computers 16a, 16b, . . . 16n for display simultaneously with search results from search engine server 84 or Web site or pages from server 86.

The collecting of data pertaining to consumer purchase behavior May the implemented by email reading software resident on the user computer or, alternatively, on a server computer of an Internet service provider. The email reading software detects whether a particular email concerns a purchase transation and if so extracts the purchase information from the email. The software may correlate information among several pieces of email correspondence to obtain all the information necessary to properly characterize the purchase transaction. The email reading software automatically determines whether an email evidences online purchase activity by a user and, upon detecting from the user's email that the user has entered into an online transaction, extracts particulars of the transaction from email to or from the user. Typically, email confirmation from merchants contains useful purchase transaction information. The extracted particulars of the purchase transaction are transmitted to a database of consumer purchasing behavior, as described hereinabove. An identity of an online shopping entity associated with the user computer is automatically established for reference in future online activity performed by the online shopping entity.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A business method comprising:
automatically determining an identity of an online shopping entity associated with a user computer logged on a computer network;
automatically selecting at least one advertisement in accordance with online purchasing behavior embodied in multiple purchases made over said computer network at a plurality of different Web sites by said online shopping entity; and
transmitting said at least one advertisement to said user computer via said computer network so that said advertisement may be presented in at least one display screen of said user computer simultaneously with primary information transmitted to said user computer via said computer network, said primary information being organized for presentation in said at least one display screen of said user computer,
the selecting of said at least one advertisement being made independently of and separately from said primary information.

2. The method defined in claim 1 wherein said online shopping entity is one online shopping entity among a multiplicity of distinct online shopping entities, the selecting of said at least one advertisement including accessing a database of consumer purchase data including multiple online purchase histories each associated with a respective online shopping entity.

3. The method defined in claim 2 wherein the selecting of said at least one advertisement includes comparing the online purchasing behavior of said one online shopping entity with statistically collated online purchase history information in said database to determine at least one potential product interest.

4. The method defined in claim 2 wherein said consumer purchase data is collected by monitoring online purchases made by said online shopping entities on said computer network.

5. The method defined in claim 4 wherein the monitoring of online purchases includes collecting of particulars as to transactions using screen scraper or data extraction software resident at least in part on multiple online computers.

6. The method defined in claim 4 wherein the monitoring of online purchases includes collecting of particulars as to transactions using email reading software.

7. The method defined in claim 4 wherein the email reading software is resident on a server computer of an Internet service provider.

8. The method defined in claim 1 wherein said primary information is taken from the group consisting of (a) results of a search executed over said computer network in response to a query from said user computer and (b) a Web page accessed by said user computer via said computer network.

9. The method defined in claim 8 wherein said search is a product search for information pertaining to one or more potential product purchases, and wherein said Web page is on a merchant Web site, further comprising transmitting to said user computer additional information taken from the group consisting of merchant popularity information and product popularity information, said additional information being adapted for display simultaneously with said primary information in said display screen.

10. The method defined in claim 9 wherein the transmitting of said additional information includes accessing a database of consumer purchase data including multiple online purchase histories each associated with a respective online shopping entity, said additional information being obtained from a statistical analysis of said consumer purchase data.

11. The method defined in claim 1 wherein said online shopping entity is taken from the group consisting of (a) said user computer and (b) an individual.

12. The method defined in claim 11 wherein determining the identity of said online shopping entity includes communicating with browser plug-in software on said user computer.

13. An online computer method comprising:
storing, in a memory of a user computer, an identity of an online shopping entity;
accessing a computer network via said user computer;
after the accessing of said computer network, transmitting the stored identity over said computer network to a source computer;
receiving, from said source computer via said computer network, at least one advertisement selected in accordance with online purchasing behavior embodied in multiple purchases made over said computer network at a plurality of different Web sites by said online shopping entity;
receiving primary information via said computer network, said primary information being organized for presentation in at least one display screen on said user computer; and
displaying said advertisement on a monitor of said user computer simultaneously with said primary information,
said at least one advertisement being selected independently of and separately from said primary information.

14. The method defined in claim 13 wherein said online shopping entity is one online shopping entity among a multiplicity of online shopping entities, said at least one advertisement is selected in accordance with consumer purchase data stored in a common database, said consumer purchase data including multiple online purchase histories each associated with a respective one of said online shopping entities.

15. The method defined in claim 14 wherein the selection of said at least one advertisement is a result of comparing the online purchasing behavior of said one online shopping entity with statistically collated online purchase history information in said database to determine at least one potential product interest of said online shopping entity.

16. The method defined in claim 13 wherein said primary information is taken from the group consisting of (a) results of a search executed over said computer network in response to a query from said user computer and (b) a Web page accessed by said user computer via said computer network, the accessing of said computer network including a step taken from the group consisting of (i) transmitting a search query to a search engine and (ii) accessing said Web page.

17. The method defined in claim 16 wherein said search is a product search for information pertaining to one or more potential product purchases, and wherein said Web page is on a merchant Web site, further comprising:
receiving additional information taken from the group consisting of merchant popularity information and product popularity information; and
displaying said additional information on said monitor simultaneously with said primary information.

18. The method defined in claim 17 wherein said additional information is obtained from a statistical analysis of said consumer purchase data.

19. A data collection method comprising:
monitoring online activity of a user conducted on a computer network via a respective user computer;
during the monitoring of said online activity, automatically determining whether the user is engaged in online purchase activity;
upon detecting that an individual user has entered into an online transaction, extracting particulars of said transaction from said user computer;
transmitting the particulars of said transaction to a database of consumer purchasing behavior; and
automatically establishing an identity of an online shopping entity associated with said user computer for reference in future online activity performed by said online shopping entity.

20. The method defined in claim 19, further comprising loading screen scraper or data mining software on said user computer and running said software during operation of a browser on said user computer.

21. The method defined in claim 19 wherein the establishing of the identity of said online shopping entity includes extracting said identity from said memory of said user computer.

22. The method defined in claim 19 wherein said online shopping entity is taken from the group consisting of (a) said user computer and (b) an individual.

23. A business computer system comprising:
at least one server computer connected to a computer network;
a database of consumer purchase data including identities of multiple online shopping entities and further including multiple online purchase histories each associated with a respective one of said online shopping entities, said multiple online purchase histories each including multiple purchases made over said computer network at a plurality of different Web sites by the respective online shopping entities, said server computer being operatively connected to said database; and
a memory storing advertisements, said server computer being operatively connected to said memory for selecting advertisements for display on a computer monitor associated with a given one of said online shopping entities simultaneously with but independently of other information and in accordance with online purchasing behavior embodied in multiple purchases made over said computer network at a plurality of different Web sites by said given one of said online shopping entities.

24. The system defined in claim 23 wherein said server computer includes means for comparing the online purchasing behavior of said given one of said online shopping entities with statistically collated online purchase history information in said database to determine at least one product potentially purchased by said given one of said online shopping entities.

25. The system defined in claim 23 wherein said server computer includes means for monitoring online purchases made by said online shopping entities on said computer network and for updating said database to incorporate online purchase data.

26. A computer network method comprising:
maintaining a database of consumer purchase data including identities of multiple online shopping entities and further including multiple online purchase histories each associated with a respective one of said onlien shopping entities, said multiple online purchase histories each including multiple purchases made over said computer network at a plurality of different Web sites by the respective online shopping entities;
accessing said database to provide consumer assistance information to a given one of said online shopping entities while same is logged onto said computer network; and
transmitting said consumer assistance information to said given one of said online shopping entities for display on a computer monitor simultaneously with other information transmitted to said given one of said online shopping entities.

27. The method defined in claim 26 wherein said consumer assistance information is taken from the group consisting of advertisements unrelated to said other information, merchant popularity information, merchant reliability data, product popularity information, products related to a product searched by said given one of said online shopping entities, and rewards and free gifts offered to a user of said given one of said online shopping entities.

28. The method defined in claim 27, further comprising automatically determining an identity of said given one of said online shopping entities, said consumer assistance information being selected in accordance with the determined identity of said given one of said online shopping entities.

29. The method defined in claim 28, further comprising:
processing information from the consumer purchase history of said given one of said online shopping entities to determine products potentially purchased by said given one of said online shopping entities;
processing information from the consumer purchase histories of others of said online shopping entities to determine purchasing interests of said others of said online shopping entities; and
comparing the determined purchasing interests of said given one of said online shopping entities with the determined purchasing interests of said others of said online shopping entities to determine at least one product potentially purchased by said given one of said online shopping entities.

30. The method defined in claim 26, further comprising automatically determining an identity of said given one of said online shopping entities, said consumer assistance information being selected in accordance with the determined identity of said given one of said online shopping entities.

31. A business computer system comprising:
at least one server computer connected to a computer network for providing information to user computers via said computer network; and
a database operatively connected to said server computer, said database storing data pertaining to buying habits of individual users determined in accordance with purchases made over said computer network via respective user computers connected to said computer network,
said server computer being programmed to:
transmit said information via said computer network to the user computers in response to queries from the user computers,
determine identities of the user computers,
transmit to each of the user computers a respective advertisement selected in accordance with past online purchases made at multiple different Web sites by on online shopper using at least the respective one of said user computers,
the advertisements being transmitted to the user computers for simultaneous display with the information on user computer monitors,
said advertisements having content independent of and separate from the information.

32. A data collection method comprising:
monitoring email of a user conducted on a computer network via a respective user computer;
during the monitoring of said email, automatically determining whether the email evidences online purchase activity by the user;
upon detecting from the user's email that the user has entered into an online transaction, extracting particulars of said transaction from email of the user;
transmitting the particulars of said transaction to a database of consumer purchasing behavior; and
automatically establishing an identity of an online shopping entity associated with said user computer for reference in future online activity performed by said online shopping entity.

33. The method defined in claim 32, wherein the monitoring of the email and the extracting of the transaction particulars includes operating a server computer to execute email reading software.

34. The method defined in claim 19 wherein the establishing of the identity of said online shopping entity includes extracting said identity from said memory of said user computer.

35. The method defined in claim 19 wherein said online shopping entity is taken from the group consisting of (a) said user computer and (b) an individual.
